(19) United States
(12) Patent Application Publication
(10) Pub. No.: US 2002/0051153 A1
(43) Pub. Date: May 2, 2002

(54) Image display method and image display apparatus

(76) Inventors: Ikuo Hiyama, Hitachi (JP); Shinichi Komura, Hitachi (JP); Tsunenori Yamamoto, Hitachi (JP); Tetsuya Aoyama, Hitachi (JP); Hideo Sato, Hitachi (JP); Makato Tsumura, Hitachi (JP); Katsumi Kondo, Mito (JP); Yuka Utsumi, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/829,078

(22) Filed: Apr. 10, 2001

(30) Foreign Application Priority Data
Jun. 8, 2000 (JP) 2000-172192

(51) Int. Cl. G06F 15/00

(52) U.S. Cl. 358/1.9

(57) ABSTRACT

A display method can achieve both of substantially high definition image display and high speed dynamic image display. The image displaying method of an image displaying apparatus having a display portion consisted of a plurality of pixels takes each of a predetermined number of pixels as one block unit and forms one screen image for displaying by combining a region for displaying the same information on a plurality of pixels in the one block unit during one scanning period and a region for permitting display of respectively different information on the plurality of pixels in the one block unit.

### BACKGROUND OF THE INVENTION

The present invention relates to an image display apparatus. More particularly, the invention relates to means for arbitrarily switching display resolution and rewriting speed of an image within a display screen.

In the recent years, reduction of thickness and weight of an image display apparatus has been progressed. In place of CRT which has been primary image display device, a flat panel display, such as a liquid crystal display, PDP (Plasma Display Panel), ELD (Electroluminescent Display) has been rapidly spreading. On the other hand, development of technology, such as FED (Field Emission Display) and so forth has been quickly progressed. Furthermore, associating with spreading of personal computer, DVD, digital broadcasting and so forth, display in high definition and high gradation or multi-level gradation has been becoming essential. Demand for higher performance, particularly higher definition level of the image display apparatus is expected to be grown toward the future.

However, in a current display method of an image or a current driving system of an image display apparatus, it is becoming difficult to adapt for increasing of display frequency associating with increased density of display due to signal delay on the line, lacking of writing period to respective pixel and increasing of scanning frequency.

On the other hand, degradation of image quality when a dynamic image is displayed in a hold illumination type image display apparatus, such as liquid crystal display, has been reported in Institute of Telecommunications Engineers Technical Report EID 96-4, pp. 19-26 (June, 1996).

According to this report, due to mismatching of a dynamic image in hold illumination and a radial motion of human eye upon following dynamic image, bluing of dynamic image can be caused to lower image quality of the dynamic image display. In order to improve lowering of image quality of the dynamic image display, a method for multiplying a frame frequency for n times and other method have been disclosed.

A method for multiplying the frame frequency for n times, upon clearly displaying dynamic image on the hold illumination type image display apparatus, such as the liquid crystal display, is a method for increasing display frequency. However, as set forth above, in the current display method of the image or the driving system of the image display apparatus, increasing of the display frequency is becoming closer to limit.

Toward the future, in order to adapt for growing high density display and dynamic image display, study has been made for new material for dynamic display and for reducing line resistance and line capacity as a factor for signal delay on the line.

On the other hand, in order to improve writing capacity for pixel, thin film transistor (TFT) using polycrystalline silicon has been recently commercialized as a replacement of the conventional TFT using amorphous silicon.

Furthermore, in Japanese Patent Application Laid-Open No. 8-006526 (1996) discloses a liquid crystal image display apparatus using means for switching single line selection and multiple line simultaneous selection for varying resolution.

However, in this technology, resolution is constant on the line. Further more, nothing has been mentioned in connection with a method for achieving both of high definition and high speed display.

Furthermore, Japanese Patent Application Laid-Open No. 9-329807(1997) discloses a liquid crystal image display apparatus which has block selection means for lowing power consumption, and rewriting only rewritten image per block. However, upon dynamic image display, in which all screen image is rewritten, high speed dynamic image display is difficult due to signal delay and limitation in writing performance.

In order to reduce signal delay on the line and enhancing writing performance, it is essential to develop material and/or process. However, there are lots of problems to be solved, such as reliability, stability, uniformity and so forth. Therefore, it is estimated to require long development period for obtaining satisfactory product.

Therefore, a displaying method or driving method capable of high definition display and dynamic image display of increased demand, have to be developed using currently available material and active element, such as TFT, MIM and so forth.

According to study of human visual characteristics, upon dynamic image display, sufficient image quality can be perceived at not so high definition since image is rewritten at high speed. On the other hand, upon still image display, while it is not necessary to rewrite the image at high speed, for perception of sufficient image quality, high definition display is required.

### SUMMARY OF THE INVENTION

It is a first object of the present invention to provide a display method which can achieve both of substantially high definition image display and high speed dynamic image display by eliminating information of lower recognition level utilizing visual characteristics f or still image display and dynamic image display.

It is a second object of the present invention to provide an image display apparatus arbitrarily switching between a region for lowering definition of dynamic image and displaying with rewriting at high speed, and a region got high definition display of still image with rewriting at low speed.

It is a third object of the present invention to provide an image display system constructed with image generating means, display control means, information storage means, and dynamic image/still image judgment means for achieving both of high definition display and high speed dynamic image display.

According to one aspect of the invention, an image displaying method of an image displaying apparatus having a display portion consisted of a plurality of pixels comprises the steps of: taking each of a predetermined number of pixels as one block unit; forming one screen image for displaying by combining a region for displaying the same information on a plurality of pixels in the one block unit during one scanning period and a region for permitting display of respectively different information on the plurality of pixels in the one block unit.

According to the second aspect of the present invention, an image displaying method of an image displaying apparatus having a display portion consisted of a plurality of pixels comprises: the steps of: taking each of a predetermined number of pixels as one block unit; discriminating an image to be displayed in each block unit between a dynamic image and a still image; forming one screen image for displaying by combining a region for displaying the same information on a plurality of pixels in the one block unit during one scanning period and a region for permitting display of respectively different information on the plurality of pixels in the one block unit.

In the preferred construction, the respective regions can be switched into regions having an arbitrary size greater than or equal to the one block unit.

The image display method may further comprise the steps of: discriminating a definition level of the still image per one block unit; and displaying the same information in arbitrarily number of plurality of pixels in the one block unit for still image of low definition level.

The one screen image may be consisted of frames in number less than or equal to number of a plurality pixels forming one block unit, and the plurality of pixels may be selected per frame.

The image display method may comprise: arranging a plurality of scanning line and a plurality of signal line of the image displaying apparatus in matrix fashion; forming switches connected to intersections of the scanning line and the signal line and whereby connected to a plurality of scanning line and a plurality of signal line; dividing opposed electrode opposing to pixel electrodes connected to the switches per a plurality of pixels; and applying driving waveforms at different levels to the signal line and the opposed electrode depending upon a region for displaying the same information and a region for permitting display of different information.

The image display apparatus is a display device which has a lighting device on a back surface, a pair of transparent substrates having polarizing panel and a liquid crystal layer disposed between the pair of transparent substrates for applying an electrical field to the liquid crystal layer for controlling orienting condition of the liquid crystal layer for displaying the image, blinking illustration of the lighting device in synchronism with scanning when the region for displaying the same information on a plurality of pixels in one block unit during one scanning period.

According to the third aspect of the present invention, an image displaying method of an image display system including an image displaying apparatus, an image generating device for generating an image signal to be displayed on the image display apparatus, a display control device for controlling the image display apparatus on the basis of the image signal and an information storage device for holding information corresponding to the image signal, comprises: the step of: discriminating a region for displaying the same information and a region for displaying different information by the image display apparatus.

According to the fourth aspect of the present invention, an image displaying method of an image display system including an image displaying apparatus, an image generating device for generating an image signal to be displayed on the image display apparatus, a display control device for controlling the image display apparatus on the basis of the image signal and an information storage device for holding information corresponding to the image signal, comprises: the step of: discriminating a region for displaying the same information and a region for displaying different information by the display control device.

According to the fifth aspect of the present invention, an image displaying method of an image display system including an image displaying apparatus, an image generating device for generating an image signal to be displayed on the image display apparatus, a display control device for controlling the image display apparatus on the basis of the image signal and an information storage device for holding information corresponding to the image signal, comprises: the step of: discriminating a region for displaying the same information and a region for displaying different information by the image generating device.

According to the sixth aspect of the present invention, an image display apparatus having a display controller for converting an image data into a display data, an image converting circuit and a display panel, comprises: a frame memory feeding data having different resolution on the display panel and a dynamic image/still image discriminating circuit; the display panel including a signal driver applying an image data signal to signal line, a control signal driver applying a scanning signal to scanning line and a pixel selection driver for applying a display block selection signal to a selection signal line, the display panel taking a predetermined number of pixels among a plurality of pixels arranged in matrix fashion as one block unit, and one screen image for displaying is formed by combining a region for displaying the same information on a plurality of pixels in the one block unit during one scanning period and a region for permitting display of respectively different information on the plurality of pixels in the one block unit.

According to the seventh aspect of the present invention, an image display apparatus having a display controller for converting an image data into a display data, an image converting circuit and a display panel, comprises: a frame memory feeding data having different resolution on the display panel and a dynamic image/still image discriminating circuit; the display panel including a signal driver applying an image data signal to signal line, a control signal driver applying a scanning signal to scanning line and a pixel selection driver for applying a display block selection signal to a selection signal line, the display panel taking a predetermined number of pixels among a plurality of pixels arranged in matrix fashion as one block unit, and one screen image for displaying is formed by combining a dynamic image region for displaying the same information on a plurality of pixels in the one block unit during one scanning period and a still image region for permitting display of respectively different information on the plurality of pixels in the one block unit, the dynamic image region is displayed on the basis of a dynamic image data from the dynamic image/still image discriminating circuit, and the still image region is displayed on the basis of the still image data from the frame memory.

The image displaying apparatus may comprise: a lighting device provided on a back surface; a pair of transparent substrates having polarizing panel; a liquid crystal layer disposed between the pair of transparent substrates; one of the pair of transparent substrates having a plurality of the scanning line, a first signal line and a second signal line formed with a plurality of the scanning lines in a form of matrix, a plurality of first switches formed corresponding to intersections of the plurality of the scanning line and a plurality of the first signal line, a plurality of second switches formed between a plurality of the second signal line and a plurality of the first switches, one of the pair of transparent substrate having a opposed electrode, an electric field being applied between the pixel electrodes and the opposed electrode, and an image being displayed by controlling orienting condition of the liquid crystal.

The display panel may have pixel electrode and opposed electrode for applying a lateral electric field to the pixel portion of the pixel and the opposed electrode.

The display panel may have the pixel electrode on one of the transparent substrates and the opposed electrode on the other transparent substrate in order to apply a vertical electric field to pixel portion of the pixel.

A color filter mounted on the pixel portion of the pixel may have a stripe structure parallel to the scanning line.

The lighting device may have lighting control means for moving a light emitting region in synchronism with a scanning signal applied to the scanning line.

The image displaying apparatus may comprise: a lighting device provided on a back surface; a pair of transparent substrates having polarizing panel; a liquid crystal layer disposed between the pair of transparent substrates; one of the pair of transparent substrates having a plurality of the scanning line, a first signal line and a second signal line formed with a plurality of the scanning lines in a form of matrix, a plurality of first switches formed corresponding to intersections of the plurality of the scanning line and a plurality of the first signal line, a plurality of second switches formed between a plurality of the second signal line and a plurality of the first switches, a pixel electrode connected to a plurality of the first switches or a plurality of the second switches, a opposed electrode connected to a plurality of the first switches or a plurality of the second switches, an electric field being applied between the pixel electrodes and the opposed electrode, and an image being displayed by controlling orienting condition of the liquid crystal.

The image displaying apparatus may comprise: a lighting device provided on a back surface; a pair of transparent substrates having polarizing panel; a liquid crystal layer disposed between the pair of transparent substrates; one of the pair of transparent substrates having a plurality of the scanning line, a first signal line and a second signal line formed with a plurality of the scanning lines in a form of matrix, a plurality of first switches formed corresponding to intersections of the plurality of the scanning line and a plurality of the first signal line, a plurality of second switches formed between a plurality of the second signal line and a plurality of the first switches, pixel electrodes connected to a plurality of the second switches, opposed electrodes on one of the pair of transparent substrate,

an electric field being applied between the pixel electrodes and the opposed electrode, and

an image being displayed by controlling orienting condition of the liquid crystal.

The display panel may have one of pixel electrode and opposed electrode for applying a lateral electric field to pixel portion of the pixel. In the alternative, the display panel may have one of pixel electrode and opposed electrode for applying a vertical electric field to pixel portion of the pixel.

The image displaying apparatus may comprise

a lighting device provided on a back surface;

a pair of transparent substrates having polarizing panel;

a liquid crystal layer disposed between the pair of transparent substrates;

one of the pair of transparent substrates having a plurality of the scanning line,

a first signal line and a second signal line formed with a plurality of the scanning lines in a form of matrix,

a plurality of switches formed corresponding to intersections of the plurality of the scanning line and a plurality of the first signal line,

pixel electrode connected to a plurality of the switches,

opposed electrode formed on one of the pair of transparent substrates and divided per a plurality of pixels,

an electric field being applied between the pixel electrodes and the opposed electrode, and

an image being displayed by controlling orienting condition of the liquid crystal.

Selection signal level to be applied to the scanning line controlling condition of the switch and selection signal level to be applied to the opposed electrode may be selection signal level having more than or equal to two values, and

a level shifter is provided for varying level of an image data signal to be applied to the signal line adapting to the selection signal level of the opposed electrode.

One block unit may be formed with predetermined number of pixels,

the scanning line selection signal level and the opposed electrode signal level for the same display on a plurality of pixels in the one block unit in one scanning period and the scanning line selection signal level and the opposed electrode signal level for selecting arbitrary pixel in the one block unit,

switching means is provided for switching the region for the same display on a plurality of pixels in the one block unit in one scanning period and the region permitting different display on a plurality of pixels in one block unit for a plurality times of scan.

According to eighth aspect of the present invention, an image displaying system comprises:

an image displaying apparatus having a display panel;

an image generating device generating an image signal displaying on the display panel;

a display control device controlling the image displaying apparatus on the basis of the image signal; and

a frame memory for holding information corresponding to the image signal connected to the display control device,

the image displaying apparatus including a dynamic image and a still image discriminating means for discriminating between the dynamic image and the still image,

the display panel taking a predetermined number of pixels among a plurality of pixels arranged in matrix fashion as one block unit, and one screen image for displaying is formed by combining a dynamic image region for displaying the same information on a plurality of pixels in the one block unit during one scanning period and a still image region for permitting display of respectively different information on the plurality of pixels in the one block unit.

According to the ninth aspect of the present invention, an image displaying system comprise:

an image displaying apparatus having a display panel;

an image generating device generating an image signal displaying on the display panel;

a display control device controlling the image displaying apparatus on the basis of the image signal; and

a frame memory for holding information corresponding to the image signal connected to the display control device,

the display control device including a dynamic image and a still image discriminating means for discriminating between the dynamic image and the still image,

the display panel taking a predetermined number of pixels among a plurality of pixels arranged in matrix fashion as one block unit, and one screen image for displaying is formed by combining a dynamic image region for displaying the same information on a plurality of pixels in the one block unit during one scanning period and a still image region for permitting display of respectively different information on the plurality of pixels in the one block unit.

According to the tenth aspect of the present invention an image displaying system comprises:

an image displaying apparatus having a display panel;

an image generating device generating an image signal displaying on the display panel;

a display control device controlling the image displaying apparatus on the basis of the image signal; and

a frame memory for holding information corresponding to the image signal connected to the display control device,

the image generating device including a dynamic image and a still image discriminating means for discriminating between the dynamic image and the still image,

the display panel taking a predetermined number of pixels among a plurality of pixels arranged in matrix fashion as one block unit, and one screen image for displaying is formed by combining a dynamic image region for displaying the same information on a plurality of pixels in the one block unit during one scanning period and a still image region for permitting display of respectively different information on the plurality of pixels in the one block unit.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing overall construction of an image display apparatus according to the present invention;

FIG. 2 is an enlarged illustration showing a part of a display area for explaining writing condition to pixels per frame in the embodiment shown in FIG. 1;

FIG. 3 is a circuit diagram showing the first embodiment of a pixel circuit construction for realizing image zone separating display according to the present invention;

FIG. 4 is a timing chart showing one example of a driving voltage waveform to be applied for each line of FIG. 3 in order to image zone separation display according to the present invention;

FIG. 5 is a plan view showing the second embodiment of a pixel structure pattern for realizing image zone separation display according to the present invention;

FIG. 6 is a plan view showing the third embodiment of a pixel structure pattern for realizing image zone separation display according to the present invention;

FIG. 7 is a plan view showing the fourth embodiment of a pixel structure pattern for realizing image zone separation display according to the present invention;

FIG. 8 is a plan view showing the fifth embodiment of a pixel structure pattern for realizing image zone separation display according to the present invention;

FIG. 9 is a timing chart showing operation waveform of the sixth embodiment applied a back light for obtaining clear dynamic image, in image zone separation display system according to the present invention;

FIG. 10 is a circuit diagram showing the seventh embodiment of a pixel circuit construction for realizing image zone separation display by the present invention;

FIG. 11 is a plan view showing the eighth embodiment of a pixel structure pattern for realizing image zone separation display according to the present invention;

FIG. 12 is a circuit diagram showing the ninth embodiment of a pixel structure pattern for realizing image zone separation display according to the present invention;

FIG. 13 is a plan view showing the tenth embodiment of a pixel structure pattern for realizing image zone separation display according to the present invention;

FIG. 14 is a plan view showing the eleventh embodiment of a pixel structure pattern for realizing image zone separation display according to the present invention;

FIG. 15 is a circuit diagram showing the twelfth embodiment of a pixel structure pattern for realizing image zone separation display according to the present invention;

FIG. 16 is a timing chart showing one example of a driving voltage waveform to be applied to each line of FIG. 15 for image zone separation display according to the present invention;

FIG. 17 is a circuit diagram showing a circuit construction for level shifting voltages of image signals 35A and 36A in the twelfth embodiment;

FIG. 18 is a plan view showing the thirteenth embodiment of a pixel structure pattern for realizing image zone separation display according to the present invention;

FIG. 19 is a plan view showing the fourteenth embodiment of a pixel structure pattern for realizing image zone separation display according to the present invention;

FIG. 20 is a plan view showing the fifteenth embodiment of a pixel structure pattern for realizing image zone separation display according to the present invention;

FIG. 21 is a plan view showing the sixteenth embodiment of a pixel structure pattern for realizing image zone separation display according to the present invention;

FIG. 22 is a timing chart showing operational waveform of the seventeenth embodiment applied a blink back light for obtaining clear dynamic image in the image zone separating display system according to the present invention;

FIG. 23 is a block diagram showing the eighteenth embodiment of an image display system adapted for image zone separating display system according to the present invention;

FIG. 24 is a block diagram showing the nineteenth embodiment of an image display system adapted for image zone separating display system according to the present invention; and

Fig.25 is a block diagram showing the twentieth embodiment of an image display system adapted for image zone separating display system according to the present invention.

### DESCRIPTION OF THE PREFERRED EMBODIMENT

The present invention will be discussed hereinafter in detail in terms of the preferred embodiments of an image display apparatus according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

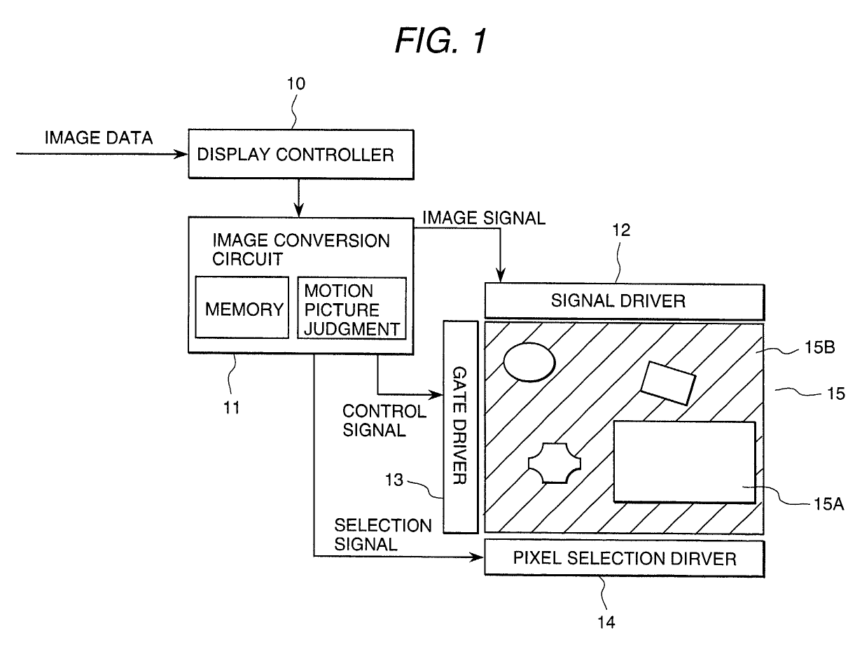

FIG. 1 is a block diagram showing the overall construction of the first embodiment of an image display apparatus according to the present invention. The shown embodiment of the image display apparatus has a display controller 10, an image conversion circuit 11 and a display panel. The display controller 10 converts an image data from a not shown image generating apparatus into a display data. The image conversion circuit 11 includes a frame memory and a dynamic image judgment circuit feeding data at different resolution to a display panel 15.

On the periphery of the display panel 15, a signal driver 12 applying an image data signal to the display panel 15, a gate driver 13 applying a scanning signal to the display panel 15 and a pixel selection driver 24 applying a selection signal for selecting a display block, are arranged.

The display panel 15 takes a plurality of pixels among a large number of pixels arranged in matrix, as one block unit, and arbitrarily switchable between a dynamic image region 15A displaying the same content on a plurality of pixel in one block in one scanning period simultaneously and a still image region 15B capable of respectively different display on a plurality of pixels in one block by a plurality of times of scan.

In the shown embodiment of the image display apparatus, data of low resolution is displayed simultaneously in one scanning period to realize smooth dynamic image display is realized, and high resolution display of still image by displaying data of high resolution by a plurality of times of scan.

Detailed construction of the display panel 15 will be discussed later. The dynamic image region 15A displaying the same content on a plurality of pixel in one block in one scanning period simultaneously and the still image region 15B capable of respectively different display on a plurality of pixels in one block by a plurality of times of scan, can be selected and can vary size or display position on the basis of input signals input from the signal driver 12, the gate driver 13 and the pixel selection driver 14.

On the other hand, it is possible to switch the portion of the still image region 15B of FIG. 1 into the dynamic image region 15A, and to switch the current dynamic image region 15A into the still image region 15B.

Furthermore, the block is divided into two sub-blocks, for example. Adapting to definition of the still image to be displayed, for the still image which can be relatively low definition, it is possible to employ a system for displaying the same information on respective sub-blocks.

Throughout the disclosure, in case of color display, one pixel is formed with three pixel components of red, green and blue. On the other hand, in case of monochrome display, one pixel is consisted of one pixel component.

[Writing/Holding Operation]

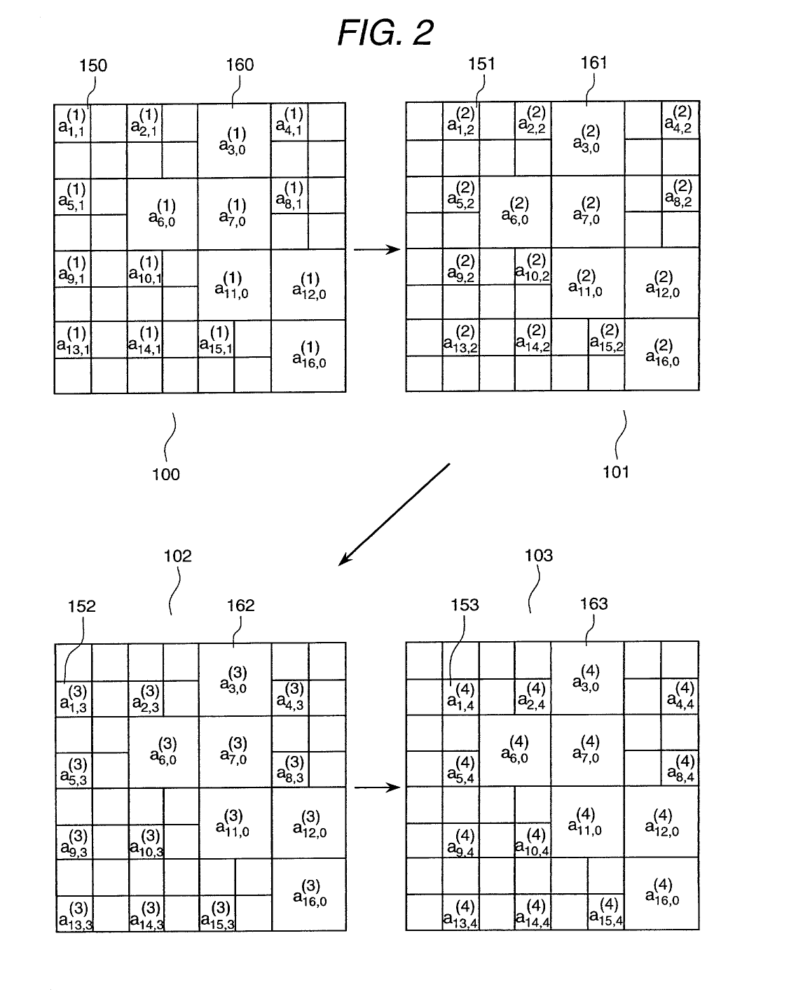

FIG. 2 is an enlarged illustration showing a part of a display area for explaining writing condition to pixels per frame in the embodiment shown in FIG. 1. In the shown embodiment, 2 pixel×2 pixel of four pixels is defined as one block.

At first, in the first frame 100, in the high definition still image region, an image data a⁽¹⁾_{1.1} is written in a pixel component 150. Similarly, even in other high definition still image regions, the image data is written in one pixel out of respective four pixels.

On the other hand, in the low definition dynamic image region, the same image data a⁽¹⁾_{3.0} is written in four pixels 160. Similarly, even in the low definition dynamic image regions, the same image data is written in respective four pixels.

Next, in the second frame 101, in the high definition still image region, with maintaining the image data a⁽¹⁾_{1.1} of the pixel 150 written in the preceding frame, image data a⁽²⁾_{1.2} is newly written in the pixel 151 in the same pixel block as the pixel 150. Similarly, in other high definition still image region, image data is newly written in the pixels different from those written in the first frame in the same pixel blocks.

On the other hand, in the low definition dynamic image region, in the same new image data a⁽²⁾_{3.0} are written for four pixels 161 of the same pixel block. Similarly, in other low definition dynamic image regions, the same new image data is written for respective four pixels in the same pixel blocks.

Next, in the third frame 102, in the high definition still image region, with maintaining the image data of the pixels 150 and 151 written in the first and second frames, image data a⁽³⁾_{1.3} is newly written in the pixel 152 in the same pixel block as the pixels 150 and 151. Similarly, in other high definition still image region, image data is newly written in the pixels different from those written in the first and second frames in the same pixel blocks.

On the other hand, in the low definition dynamic image region, in the same new image data a⁽³⁾_{3.0} is written for four pixels 162 of the same pixel block. Similarly, in other low definition dynamic image regions, the same new image data is written for respective four pixels in the same pixel blocks.

Next, in the fourth frame 103, in the high definition still image region, with maintaining the image data of the pixels 150 and 151 written in the first and second frames, image data a⁽⁴⁾_{1.4} is newly written in the pixel 153 in the same pixel block as the pixels 150, 151 and 152. Similarly, in other high definition still image region, image data is newly written in the pixels different from those written in the first, second and third frames in the same pixel blocks.

On the other hand, in the low definition dynamic image region, in the same new image data a⁽⁴⁾_{3.0} is written for four pixels 163 of the same pixel block. Similarly, in other low definition dynamic image regions, the same new image data is written for respective four pixels in the same pixel blocks.

By repeating the foregoing steps, the high definition still image regions and the low definition dynamic image regions are displayed in the arbitrary regions in the display area.

The high definition still image region forms high definition image by four frames and the low definition dynamic image region displays new data per one frame. Accordingly, the still image not varying in four frames can be displayed in high definition, and the dynamic image moving quickly can be displayed at high speed per one frame.

Throughout the disclosure, the system of display varying resolution in arbitrary region in the display area as set forth above will be referred to as image zone separating display system.

[First Embodiment]

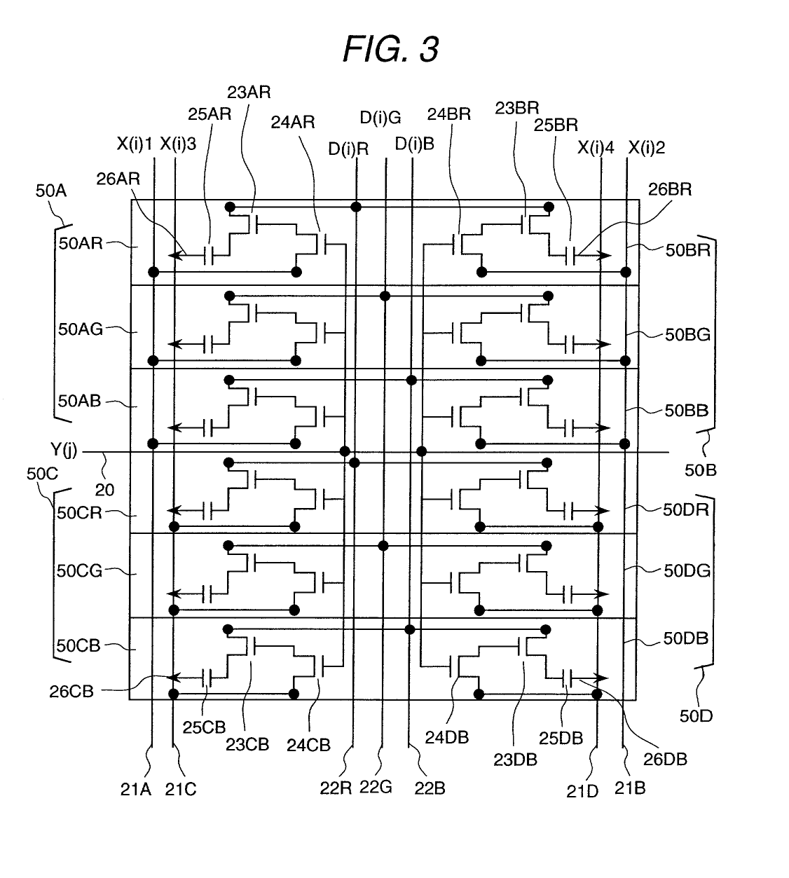

FIG. 3 is a circuit diagram showing an embodiment of a pixel circuit construction for realizing image zone separating display according to the present invention.

The first embodiment is a pixel circuit construction taking 2 pixels×2 pixels as one block. A plurality of such pixel circuit constructions are arranged for forming overall display area of the display panel 15. It should be noted that one pixel block is not necessarily consisted of four pixels but can be any reasonable number. However, in consideration of lowering opening ratio due to increasing of line and so forth, it is preferred to form one pixel block with four pixels.

It should be noted that the image display apparatus employing the image zone separating display system of the present invention is not only applicable for the liquid crystal display but also for ELD, FED, PDP and so forth. Here, the present invention will be discussed in terms of the liquid crystal display as the most preferred example.

The first embodiment of the liquid crystal display has a lighting device on a back surface and includes a pair of transparent substrates having a polarizing panel and a liquid crystal layer sandwiched between a pair of transparent substrate, controls orienting condition of the liquid crystal layer by applying an electrical field to the liquid crystal layer for displaying image.

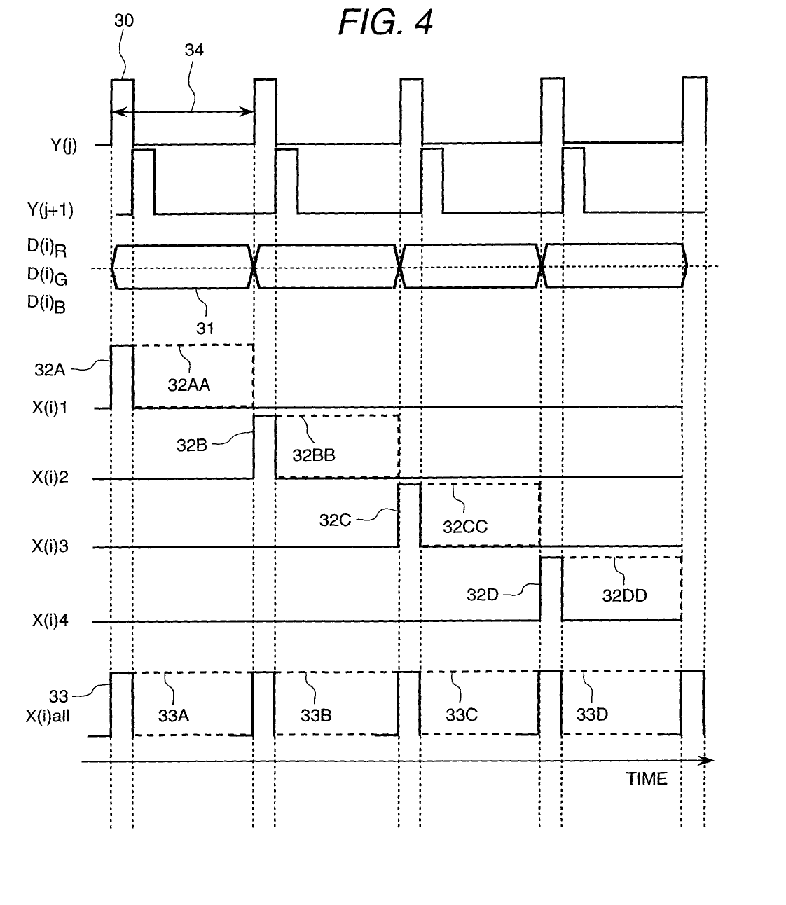

In the circuit construction of one pixel block constituted of four pixels as shown in FIG. 4, concerning respective components, upper left pixel is identified by A, the upper right pixel is identified by B, the lower left pixel is identified by C and the lower right pixel is identified by D. Furthermore, R, G. B are given corresponding to respective of red, green and blue pixels.

In the first embodiment, one block is constituted with four pixels 50A, 50B, 50C and 50D. The pixel 50A is consisted of three pixel components of red pixel component 50AR, green pixel component 50AG and blue pixel component 50AB. The pixel 50B is consisted of three pixel components of red pixel component 50BR, green pixel component 50BG and blue pixel component 50BB. The pixel 50C is consisted of three pixel components of red pixel component 50CR, green pixel component 50CG and blue pixel component 50CB. The pixel 50D is consisted of three pixel components of red pixel component 50DR, green pixel component 50DG and blue pixel component 50DB.

Scanning line 20 common for four pixels is formed at the center. To the scanning line 20, gates, such as twelve thin film transistors 24AR, 24BR, 24CB and 24DB as a first switch and so forth are connected.

To drain electrodes of the thin film transistors 24AR, 24AG and 24AB as the first switches, a block selection signal line 21A is connected. To drain electrodes of the thin film transistors 24BR, 24BAG and 24BB, a block selection signal line 21C is connected. To drain electrodes of the thin film transistors 24CR, 24CG and 24CB, a block selection signal line 21C is connected. To drain electrodes of the thin film transistors 24DR, 24DG and 24DB, a block selection signal line 21D is connected.

The thin film transistors 24AR, 24AG and 24AB as the first switches are switches for selecting the pixel 50A, respectively. These first switches may be a common single switch. Similarly, concerning the pixels 50B, 50C and 50D, the first switches may be respective of common single switches.

To source electrodes of the thin film transistors as the first switches, twelve gate electrodes, such as thin film transistors 23AR, 23BR, 23CB, 23DB and so forth as second switches are connected.

To drain electrodes of thin film transistors as second switches, respective of red color image signal line 22R, green color image signal line 22G and blue color image signal line 22B are connected.

To the source electrodes of the thin film transistors as the second switches, electrodes of respective pixel components are connected. Across liquid crystal layer, opposed electrodes 26AR, 26BR, 26CB, 26DB and so forth are connected for forming pixel components 25AR, 25BR, 25CB, 25DB and so forth are formed.

Opposed electrodes are common electrodes for all pixels. In respective of the pixel components 25AR, 25BR, 25CB, 25 DB and so forth, holding capacitors are formed in parallel.

By employing such pixel circuit construction, the image zone separating display discussed in connection with FIG. 2 can be performed.

On the other hand, in the shown embodiment, in FIG. 3, to the gates of the first switches, scanning line 20 are connected, and to the drain electrodes of the first switches, block selection signal line are connected. However, in the alternative, it is possible to take a circuit construction, in which the block signal selection line per pixel are connected to respective gates and scanning line 20 is connected to drain electrodes of all of four pixels.

FIG. 4 is a timing chart showing one example of the driving voltage waveform applied to each line of FIG. 3 for image zone separation display. Considering(j)th scanning lineY(j). On the scanning line Y(j), a gate voltage 30 for turning ON the thin film transistor as the first switch is applied per a frame period 34. In synchronism with the gate electrode 30, voltages 32A to 32D are applied to respective block selection signal line X(i)₁ to X(i)₄, 21A to 21D per four blocks and image signal 31 corresponding to red color (i)_{R}, green color (i)_{G} and blue color (i)_{B} is applied to the pixel through the second switch in synchronism with the gate voltage 30, in the region for high definition display.

Accordingly, only one of the pixels 50A, 50B, 50C and 50D is selected. Also, in the pixels not selected, voltages are held for four frames.

On the other hand, in the region to perform low definition display, a voltage 33 is applied to block selection signal line X(i)ₐₗₗ as 21A to 21D, respectively per frame. The image signal 31 corresponding to red color (i)_{R}, green color (i)_{G} and blue color (i)_{B} is applied to the pixel through the second switch in synchronism with the gate voltage 30. Accordingly, the same signal is applied for all pixels 50A, 50B, 50C and 50D for enabling rewriting of the display common to four pixels.

Concerning the (j+1)th scanning line Y(j+1), similarly to the (j)th scanning line, the high definition display region and the low definition display region are discriminated. When the driving waveform is input, image zone separating display can be performed.

Accordingly, when the still image is displayed on the high definition display region and the dynamic image is displayed on the low definition display region, the dynamic image is rewritten and the still image is displayed in high definition.

[Second Embodiment]

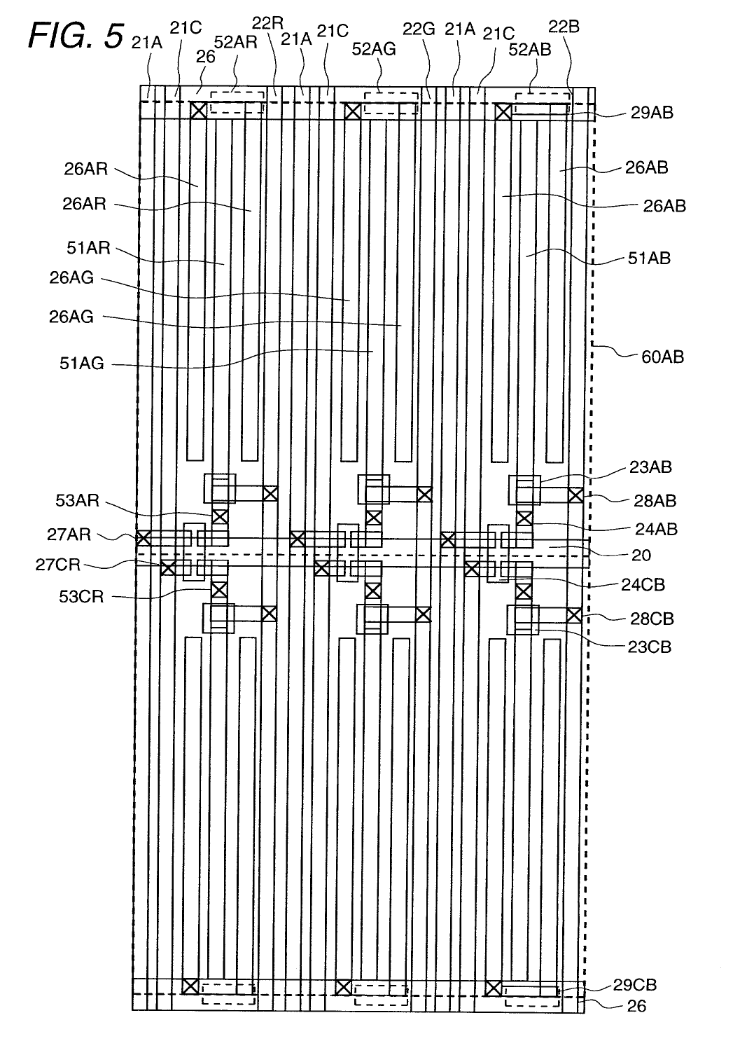

FIG. 5 is a plan view showing embodiment of pixel structure pattern for realizing image zone separation display according to the present invention.

The second embodiment is provided with a pixel electrode and a opposed electrode on the same substrate and is a system for applying a lateral electric field to the liquid crystal layer. In the second embodiment, 2×2 pixels are taken as one block unit. A plurality of block units are arranged for forming entire display area. Number of pixels forming one block unit is not specified to four but can be of any number. However, in consideration of lowering opening ratio due to increasing of line and so forth, it is preferred to form one pixel block with four pixels.

It should be noted that the image display apparatus employing the image zone separating display system of the present invention is not only applicable for the liquid crystal display but also for ELD, FED, PDP and so forth. Here, the present invention will be discussed in terms of the liquid crystal display as the most preferred example.

The second embodiment of the liquid crystal display has a lighting device on a back surface and includes a pair of transparent substrates having a polarizing panel and a liquid crystal layer sandwiched between a pair of transparent substrate, controls orienting condition of the liquid crystal layer by applying an electrical field to the liquid crystal layer for displaying image.

In the second embodiment, one pixel is consisted of three pixel components of red, green and blue, and one block is consisted of four pixels.

It should be noted that FIG. 5 only two pixels are shown for the purpose of illustration. For respective components associated with upper left pixel are identified by adding A following reference numerals, and for respective components associated with lower left pixel are identified by adding C. Corresponding to pixel components of red, green and blue, R, G and B are added. Accordingly, among four pixels, upper right pixel B and lower right pixel Dare not illustrated. The scanning line 20 common for four pixels is formed at the center. To the scanning line 20, the gates of the thin film transistors 24AB, 24CB and so forth as the first switch are connected. In the second embodiment, a color filter has a stripe structure perpendicular to the scanning line 20.

To drain electrodes of the thin film transistors 24AB, and 24CB as the first switches, block selection signal line 21A and 21C are connected by contact portions 27AB and 27CB.

To the source electrodes of the thin film transistors as the first switch, gate electrodes of the thin film transistors 23AB and 23CB as the second switch are connected by the contact portions 53AB and 53CB.

To the drain electrodes of the thin film transistors as the second switches, respective of red color image signal line 22R, green color image signal line 22G and blue color image signal line 22B are connected through contact portions 28AR, 28AG and 28AB.

To the source electrodes of the thin film transistors as the second switches, respective electrodes 51AR, 51AG and 51AB of the pixel components are connected, and across the liquid crystal layer, opposed electrodes 24AR, 26BR, 26CB and 26DB and so forth are connected.

The opposed electrodes are electrodes common for all pixels.

It should be noted that the holding capacitors 52AR, 52AG and 52AB of the pixel components are formed in parallel with respective pixel components.

In the shown embodiment, electrodes at different layers are connected by the contact portions 27, 28, 29, 53 and so forth. The layer structure is not limited to the shown example.

Employing the second embodiment of the pixel structure and driving the same in similar manner as the first embodiment, image zone separation display becomes possible.

[Third Embodiment]

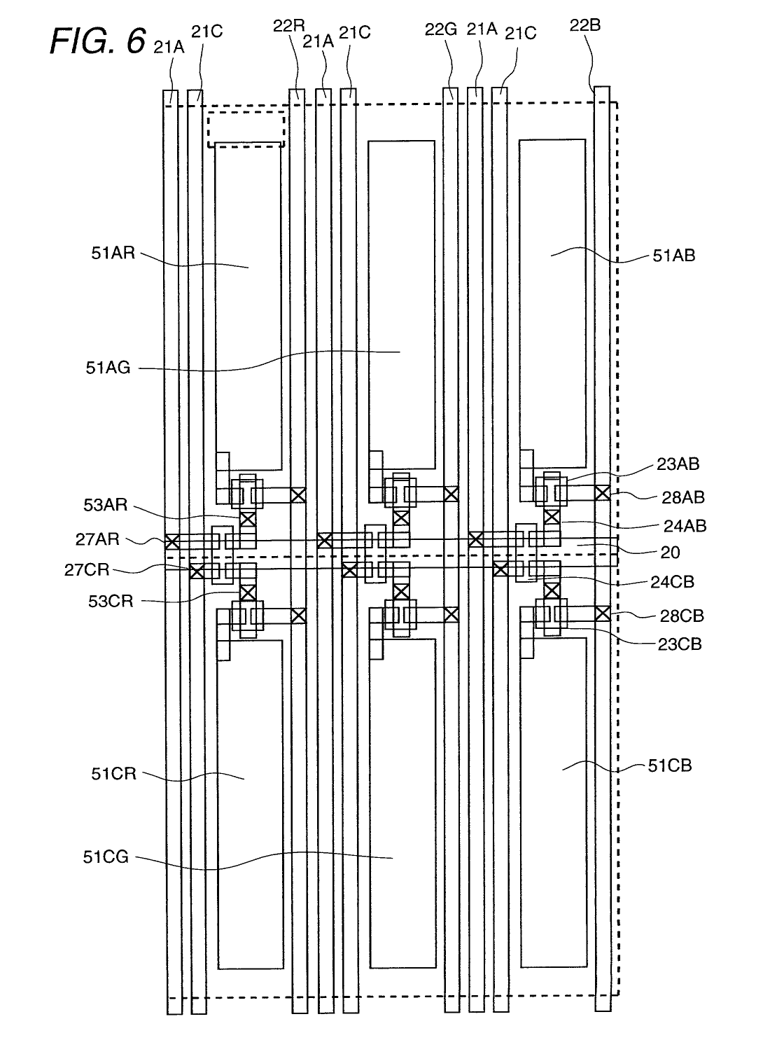

FIG. 6 is a plane view of the third embodiment of the pixel structure pattern for realizing the image zone separation display according to the present invention. The third embodiment has a pixel electrode on one of a pair of transparent substrates and a opposed electrode on the other transparent substrate. A vertical electric field is applied the liquid crystal layer. In the third embodiment, a color filter has a stripe structure perpendicular to the scanning line 20.

The scanning line 20 common for four pixels are formed at the center. To the scanning line 20, the gates of the thin film transistors 24AB, 24CB are connected. To drain electrodes of the thin film transistors 24AB, and 24CB as the first switches, block selection signal line 21A and 21C are connected by contact portions 27AB and 27CB.

To the source electrodes of the thin film transistors as the first switch, gate electrodes of the thin film transistors 23AB and 23CB as the second switch are connected by the contact portions 53AB and 53CB.

To the drain electrodes of the thin film transistors as the second switches, respective of red color image signal line 22R, green color image signal line 22G and blue color image signal line 22B are connected through contact portions 28AR, 28AG and 28AB.

To the source electrodes of the thin film transistors as the second switches, respective electrodes 51AR, 51AG and 51AB of the pixel components are connected, and across the liquid crystal layer, opposed electrodes 24AR, 26BR, 26CB and 26DB and so forth are connected.

The opposed electrodes are electrodes common for all pixels.

It should be noted that the holding capacitors 52AR, 52AG and 52AB of the pixel components are formed in parallel with respective pixel components.

In the shown embodiment, electrodes at different layers are connected by the contact portions 27, 28, 53 and so forth. The layer structure is not limited to the shown example.

Employing the third embodiment of the pixel structure and driving the same in similar manner as the first embodiment, image zone separation display becomes possible.

[Fourth Embodiment]

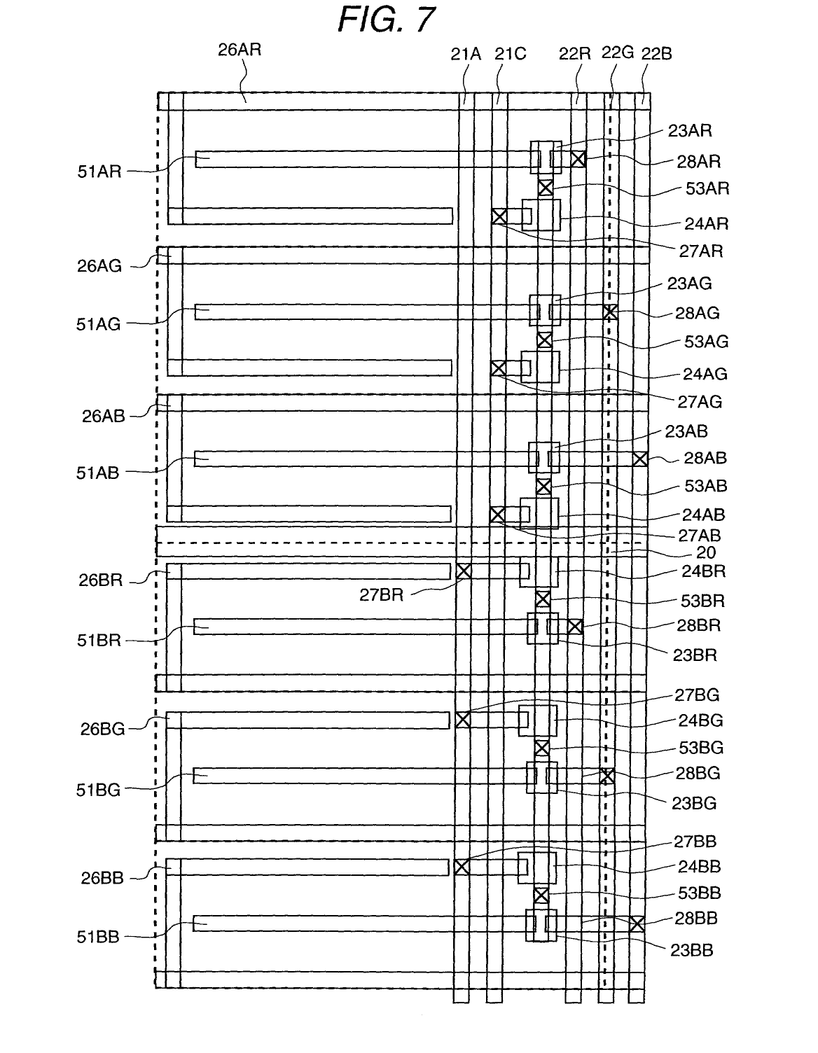

FIG. 7 is a plane view of the fourth embodiment of the pixel structure pattern for realizing the image zone separation display according to the present invention. The fourth embodiment is substantially the same as the second embodiment except for the color filter which is constructed with a stripe structure parallel to the scanning line 20.

By employing the construction of the fourth embodiment, opening ratio can be risen in comparison with the second embodiment.

[Fifth Embodiment]

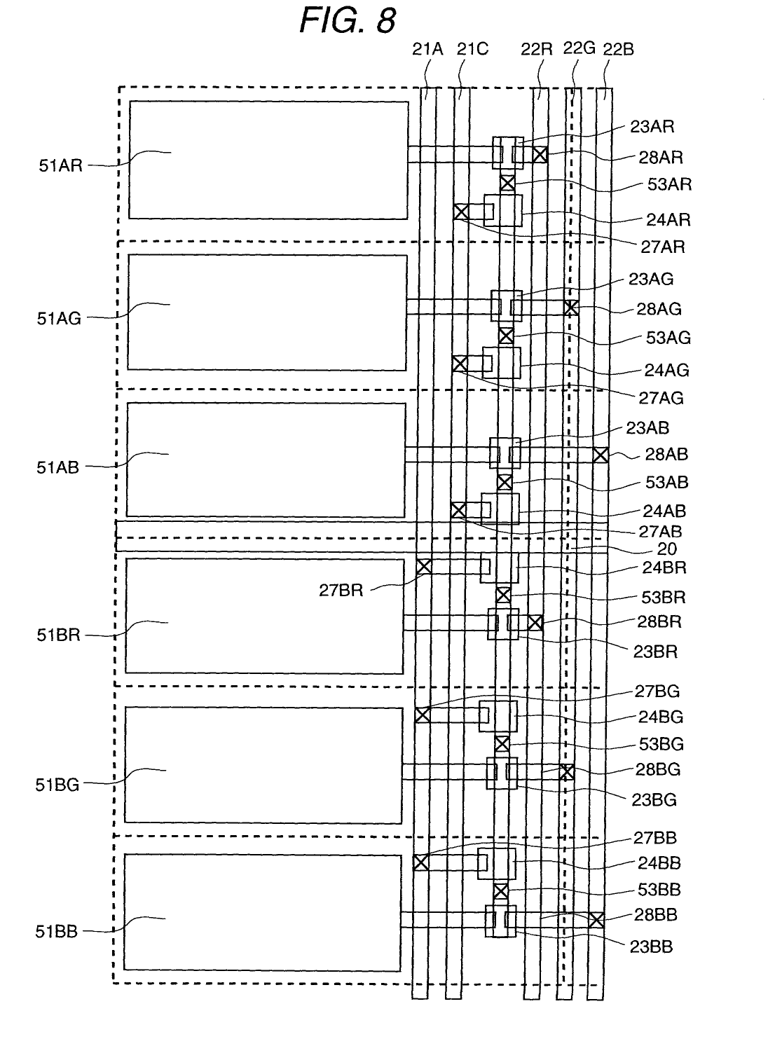

FIG. 8 is a plane view of the fifth embodiment of the pixel structure pattern for realizing the image zone separation display according to the present invention. The fifth embodiment is substantially the same as the second embodiment except for the color filter which is constructed with a stripe structure parallel to the scanning line 20.

By employing the construction of the fifth embodiment, opening ratio can be risen in comparison with the third embodiment.

[Sixth Embodiment]

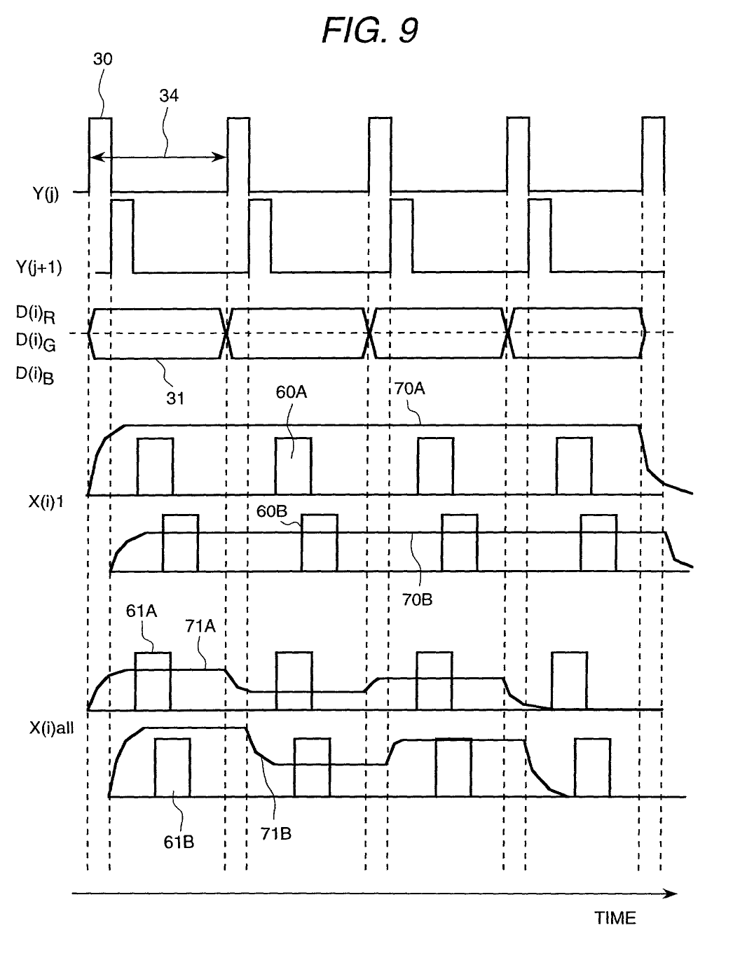

FIG. 9 is a timing chart showing operation waveform of the embodiment applied blink back light for obtaining clear dynamic image in the image zone separation display system according to the present invention.

The sixth embodiment is applicable for any embodiments having two switches in one pixel component.

The sixth embodiment of the liquid display also has the lighting device on the back surface, a pair of transparent substrates having polarizing panel, and a liquid crystal layer disposed between a pair of transparent substrates. By applying an electric field to the liquid crystal layer, orienting condition of the liquid crystal is controlled for displaying the image.

Upon high resolution display, a coefficient of transmission of the liquid crystal layer is varied as curves 70A and 70B, and upon low definition display, the coefficient of transmission of the liquid crystal layer is varied as curves 71A and 71B. When the lighting device is illuminated as shown by curves 60A, 60B, 61A and 61B in synchronism with response of the liquid crystal, clear image can be obtained within a region rewritten at high speed at low definition.

When illumination of the lighting device dividing the high definition region and the low definition region is difficult, in order to prevent fluctuation of brightness in the high definition region and brightness in the low definition region, illumination of the lighting device has to be blinked in synchronism with the scanning line signal 30.

[Seventh Embodiment]

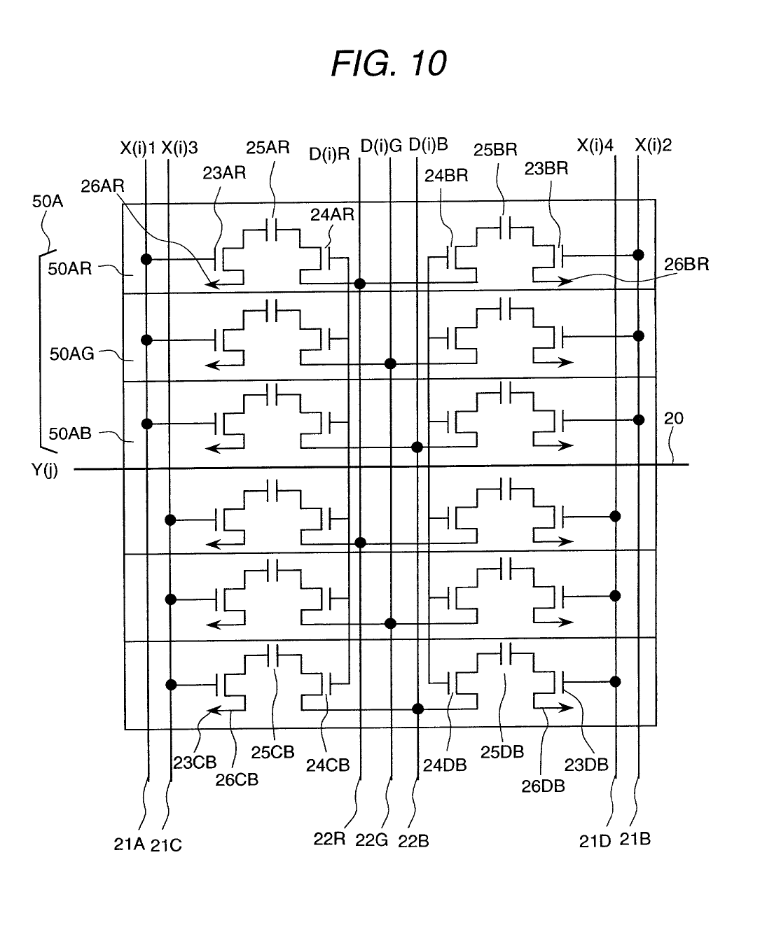

FIG. 10 is a circuit diagram showing the seventh embodiment of the pixel circuit construction for realizing the image zone separation display according to the present invention.

The shown embodiment has a pixel circuit construction with taking 2×2 pixels as one block unit. A plurality of block units are arranged for forming entire display area. Number of pixels forming one block unit is not specified to four but can be of any number. However, in consideration of lowering opening ratio due to increasing of line and so forth, it is preferred to form one pixel block with four pixels.

It should be noted that the image display apparatus employing the image zone separating display system of the present invention is not only applicable for the liquid crystal display but also for ELD, FED, PDP and so forth. Here, the present invention will be discussed in terms of the liquid crystal display as the most preferred example.

The seventh embodiment of the liquid crystal display has a lighting device on a back surface and includes a pair of transparent substrates having a polarizing panel and a liquid crystal layer sandwiched between a pair of transparent substrate, controls orienting condition of the liquid crystal layer by applying an electrical field to the liquid crystal layer for displaying image.

In the seventh embodiment, one pixel is consisted of three pixel components of red pixel component 50AR, green pixel component 50AG and blue pixel component 50AB, and one block is consisted of four pixels 50A, 50B, 50C and 50D.

In the circuit construction of one pixel block constituted of four pixels as shown in FIG. 10, concerning respective components, upper left pixel is identified by A, the upper right pixel is identified by B, the lower left pixel is identified by C and the lower right pixel is identified by D. Furthermore, R, G. B are given corresponding to respective of red, green and blue pixels.

Scanning line 20 common for four pixels is formed at the center. To the scanning line 20, gates, such as twelve thin film transistors 24AR, 24BR, 24CB and 24DB as a first switch.

To the gate electrodes of the thin film transistors 23AR, 23AG, 23AB as second switch, the block selection signal line 21A is connected.

To the gate electrodes of the thin film transistors 23BR, 23BG, 23BB as second switch, the block selection signal line 21B is connected. To the gate electrodes of the thin film transistors 23CR, 23CG, 23CB as second switch, the block selection signal line 21C is connected. To the gate electrodes of the thin film transistors 23DR, 23DG, 23DB as second switch, the block selection signal line 21D is connected.

To the drain electrodes of the second switches, the electrodes 26AR, 26BR, 26CB, 26DB and so forth are connected and are respective made in common.

To the drain electrode of the thin film transistors of the first switch, respective of red color image signal line 22R, the green color image signal line 22G and the blue color image signal line 22B are connected.

The source electrodes of the thin film transistors as the first switch serve as electrodes of the pixel components.

To the twelve source electrodes of the thin film transistors 23AR, 23BR, 23CB, 23DB and so forth as the second switches, opposed electrodes are formed. By sandwiching the liquid crystal layer between the pixel electrode and the opposed electrode to form pixel components 25AR, 25BR, 25CB, 25DB and so forth.

Employing the pixel construction of the seventh embodiment, and driving the same in similar manner as the first embodiment, image zone separation display becomes possible.

On the other hand, in the shown embodiment, while the scanning line 20 is connected to the gate electrode of the first switch and the block selection signal line is connected to the gate electrode of the second switch in FIG. 10, replacing with this, the block selection signal line may be connected to the gate electrode of the first switch per pixel, and scanning line 20 may be connected to the gate electrode of the second switch of all four pixels.

It should be noted that the driving voltage waveform applied to respective line for image zone separation display is a same as that shown in FIG. 4 in connection with the first embodiment.

Accordingly, when the still image is displayed in the high definition region and the dynamic image is displayed in the low definition region, dynamic image and still image are displayed in admixed manner, the dynamic image is rewritten at high speed and still image is displayed at high definition.

[Eighth Embodiment]

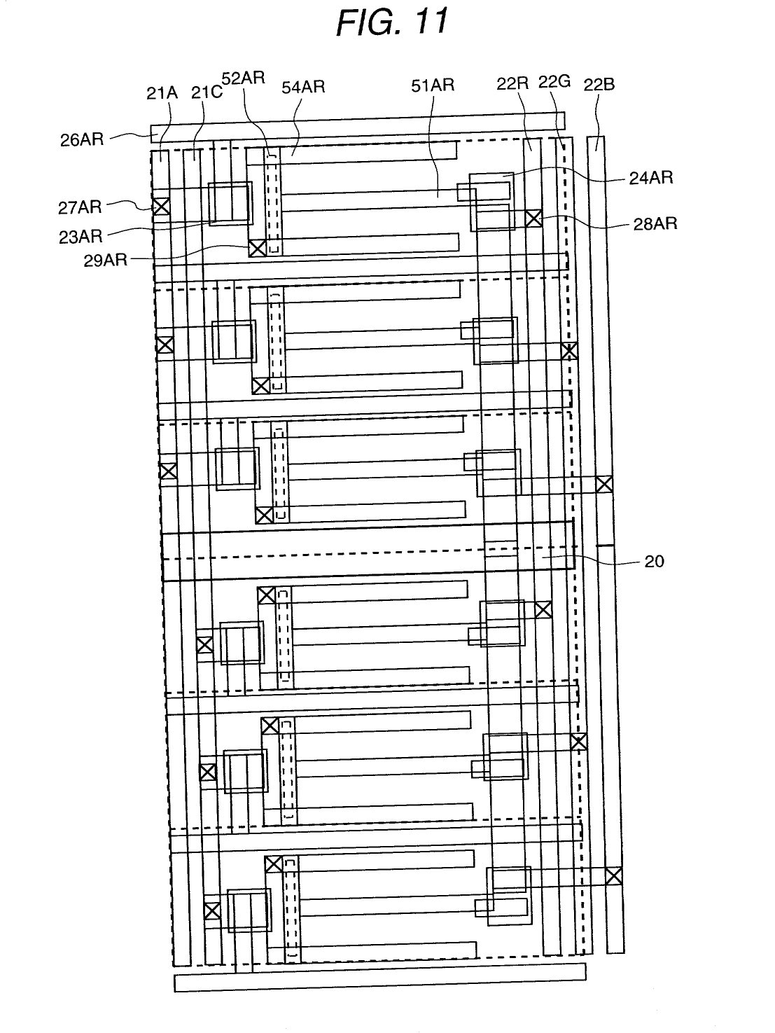

FIG. 11 is a plan view showing the eighth embodiment of a pixel structure pattern for realizing image zone separation display according to the present invention.

The eighth embodiment is a system for applying the lateral electric field to the liquid crystal layer with the pixel electrode and the opposed electrode on the same substrate in the seventh embodiment. The color filter has a stripe structure in parallel to the scanning line 20 to improve opening ratio.

However, the color filter may be the stripe structure perpendicular to the scanning line 20.

On the other hand, in the eighth embodiment, while the electrodes at different layers are connected by contact portions 27, 28, 29 and so forth, the layer structure is not limited to the shown structure.

Other operation and effect of the eighth embodiment are similar to the seventh embodiment.

[Ninth Embodiment]

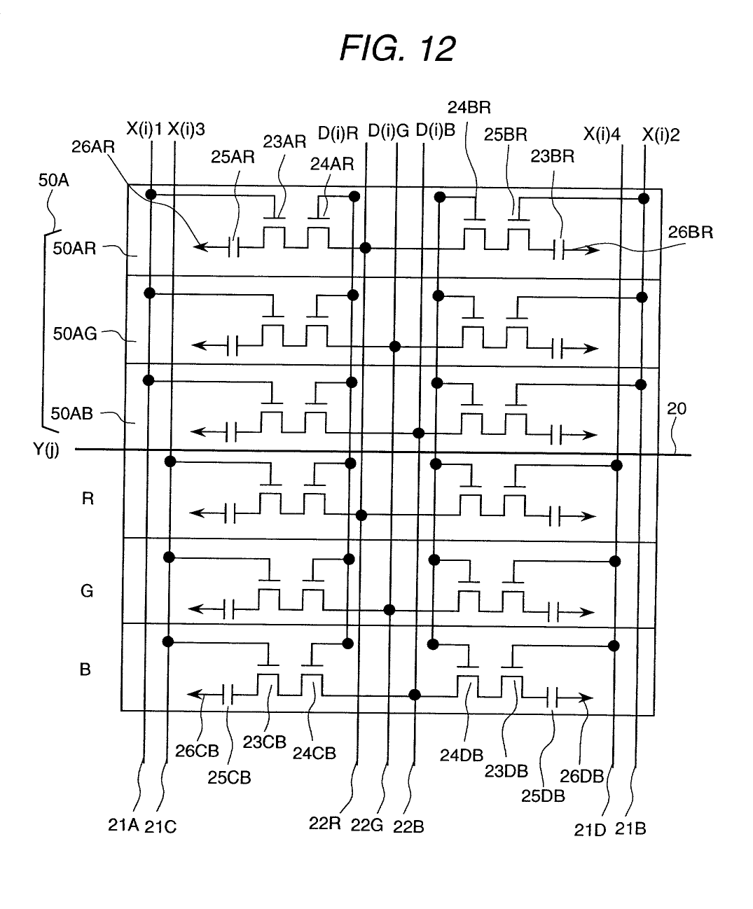

FIG. 12 is a circuit diagram showing the ninth embodiment of a pixel structure pattern for realizing image zone separation display according to the present invention.

The ninth embodiment is provided with a pixel electrode and a opposed electrode on the same substrate and is a system for applying a lateral electric field to the liquid crystal layer. In the second embodiment, 2×2 pixels are taken as one block unit. A plurality of block units are arranged for forming entire display area. Number of pixels forming one block unit is not specified to four but can be of any number. However, in consideration of lowering opening ratio due to increasing of line and so forth, it is preferred to form one pixel block with four pixels.

It should be noted that the image display apparatus employing the image zone separating display system of the present invention is not only applicable for the liquid crystal display but also for ELD, FED, PDP and so forth. Here, the present invention will be discussed in terms of the liquid crystal display as the most preferred example.

The ninth embodiment of the liquid crystal display has a lighting device on a back surface and includes a pair of transparent substrates having a polarizing panel and a liquid crystal layer sandwiched between a pair of transparent substrate, controls orienting condition of the liquid crystal layer by applying an electrical field to the liquid crystal layer for displaying image.

In the ninth embodiment, one pixel is consisted of three pixel components of red pixel component 50AR, green pixel component 50AG and blue pixel component 50AB, and one block is consisted of four pixels 50A, 50B, 50C and 50D.

In the circuit construction of one pixel block constituted of four pixels as shown in FIG. 12, concerning respective components, upper left pixel is identified by A, the upper right pixel is identified by B, the lower left pixel is identified by C and the lower right pixel is identified by D. Furthermore, R, G. B are given corresponding to respective of red, green and blue pixels.

Scanning line 20 common for four pixels is formed at the center. To the scanning line 20, gates, such as twelve thin film transistors 24AR, 24BR, 24CB and 24DB as a first switch.

To the gate electrodes of the thin film transistors 23AR, 23AG, 23AB as second switch, the block selection signal line 21A is connected.

To the gate electrodes of the thin film transistors 23BR, 23BG, 23BB as second switch, the block selection signal line 21B is connected.

To the gate electrodes of the thin film transistors 23CR, 23CG, 23CB as second switch, the block selection signal line 21C is connected.

To the gate electrodes of the thin film transistors 23DR, 23DG, 23DB as second switch, the block selection signal line 21D is connected.

The source electrode of the thin film transistor as the first switch is connected to the drain electrode of the thin film transistor as the second switch.

To the source electrodes of the thin film transistors as the second switches, electrodes of respective pixel components are connected. Across liquid crystal layer, opposed electrodes 26AR, 26BR, 26CB, 26DB and so forth are connected for forming pixel components 25AR, 25BR, 25CB, 25DB and so forth are formed.

Opposed electrodes 26AR, 26BR, 26CB, 26DB and so forth are common electrodes for all pixels.

In respective of the pixel components 25AR, 25BR, 25CB, 25 DB and so forth, holding capacitors are formed in parallel.

When the pixel is constructed as set forth above, the image zone separation display discussed in connection with FIG. 2 can be realized.

In the shown embodiment illustrated in FIG. 12, the scanning line 20 is connected to the gate electrode of the first switch, and block selection signal line is connected to the gate electrode of the second switch. However, in the alternative, it is possible to take a circuit construction, in which the block signal selection line per pixel are connected to respective gates and scanning line 20 is connected to drain electrodes of all of four pixels.

It should be noted that the driving voltage waveform applied to respective line for image zone separation display is a same as that shown in FIG. 4 in connection with the first embodiment.

Accordingly, when the still image is displayed in the high definition region and the dynamic image is displayed in the low definition region, dynamic image and still image are displayed in admixed manner, the dynamic image is rewritten at high speed and still image is displayed at high definition.

[Tenth Embodiment]

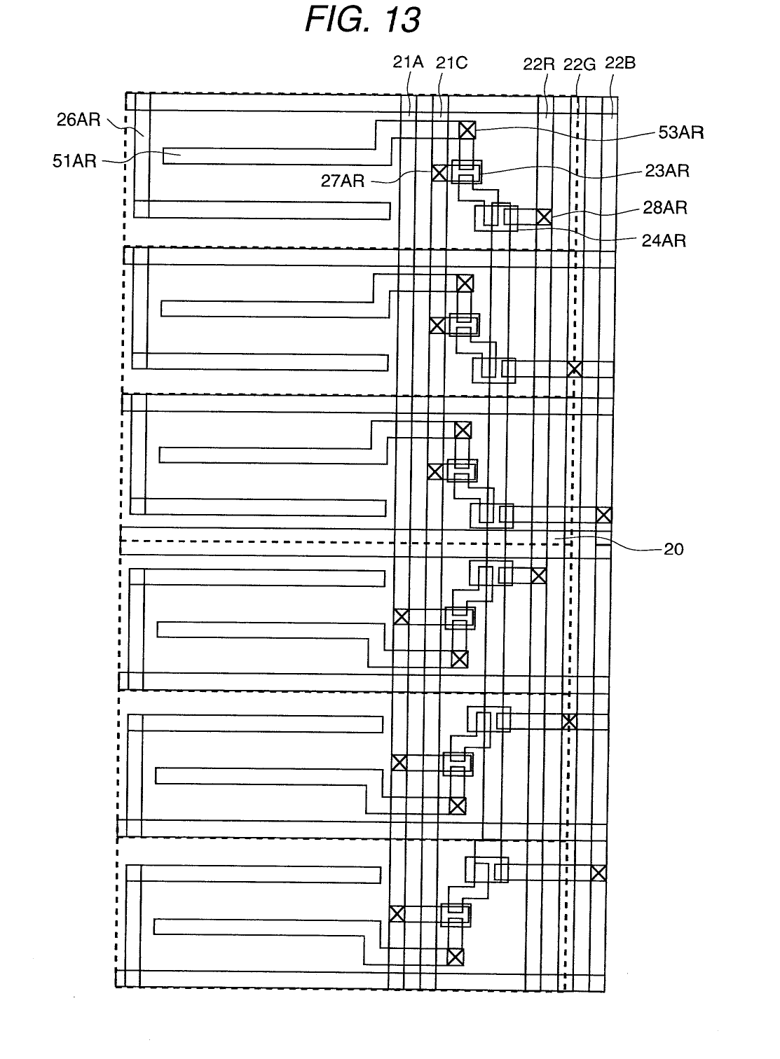

FIG. 13 is a plan view showing the tenth embodiment of a pixel structure pattern for realizing image zone separation display according to the present invention.

The tenth embodiment is a system for applying the lateral electric field to the liquid crystal layer with the pixel electrode and the opposed electrode on the same substrate in the ninth embodiment. The color filter has a stripe structure in parallel to the scanning line 20 to improve opening ratio. However, the color filter may be the stripe structure perpendicular to the scanning line 20.

On the other hand, in the eighth embodiment, while the electrodes at different layers are connected by contact portions 27, 28, 53 and so forth, the layer structure is not limited to the shown structure.

Other operation and effect of the eighth embodiment are similar to the seventh embodiment.

[Eleventh Embodiment]

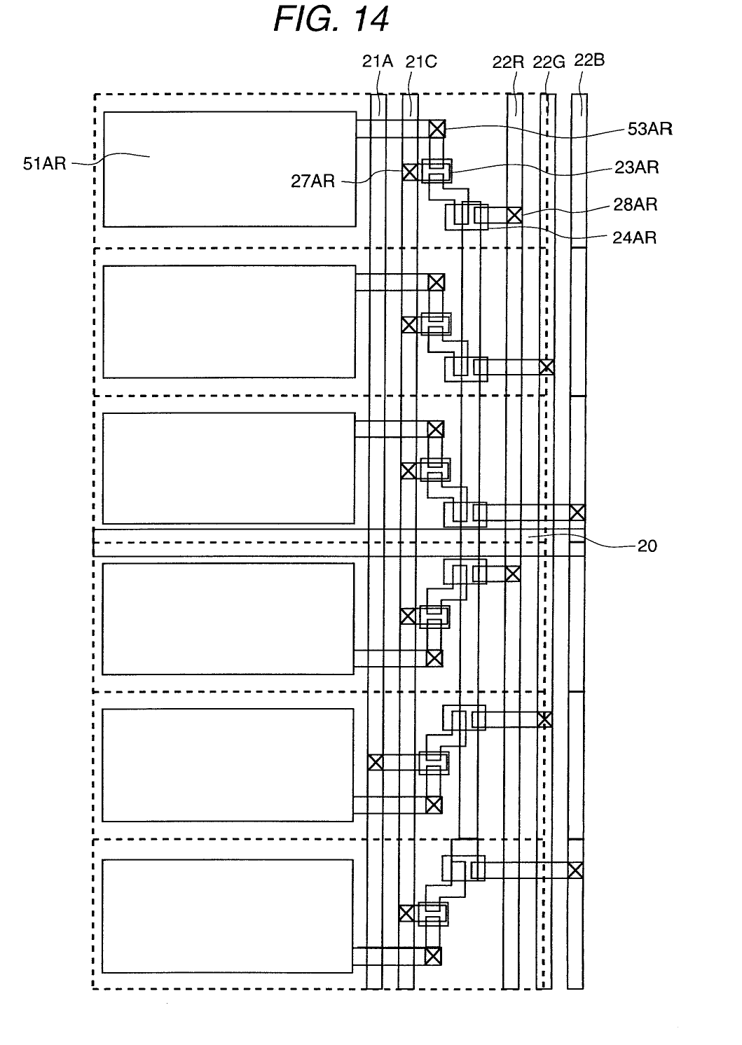

FIG. 14 is a plan view showing the eleventh embodiment of a pixel structure pattern for realizing image zone separation display according to the present invention.

The eleventh embodiment is a system for applying the lateral electric field to the liquid crystal layer with the pixel electrode and the opposed electrode on the same substrate in the tenth embodiment. Other operation and effect are the similar to the tenth embodiment.

[Twelfth Embodiment]

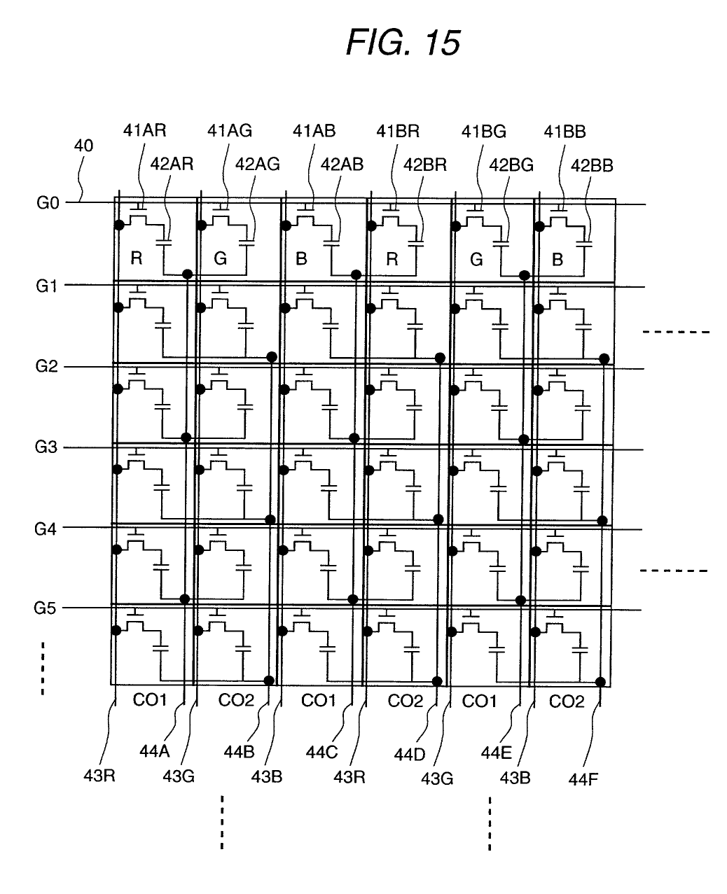

FIG. 15 is a circuit diagram showing the twelfth embodiment of a pixel structure pattern for realizing image zone separation display according to the present invention.

The twelfth embodiment is a pixel circuit construction taking 2 pixels×2 pixels as one block. A plurality of such pixel circuit constructions are arranged for forming overall display area of the display panel 15. It should be noted that one pixel block is not necessarily consisted of four pixels but can be any reasonable number. However, in consideration of lowering opening ratio due to increasing of line and so forth, it is preferred to form one pixel block with four pixels.

It should be noted that the image display apparatus employing the image zone separating display system of the present invention is not only applicable for the liquid crystal display but also for ELD, FED, PDP and so forth. Here, the present invention will be discussed in terms of the liquid crystal display as the most preferred example.

The twelfth embodiment of the liquid crystal display has a lighting device on a back surface and includes a pair of transparent substrates having a polarizing panel and a liquid crystal layer sandwiched between a pair of transparent substrate, controls orienting condition of the liquid crystal layer by applying an electrical field to the liquid crystal layer for displaying image.

In the twelfth embodiment, one pixel is consisted of three pixel components, and one pixel block is consisted of four pixels.

To the scanning line 40, the gate electrodes of the thin film transistors 41AR, 41AG, 41AB and so forth as switch are connected per one pixel component. To the drain electrode of the thin film transistor 41, the red image signal line 43R, the green image signal line 43G and the blue image signal line 43B are connected, respectively.

To the source electrode of the thin film transistor 41, pixel electrode is connected. The liquid crystal layer is sandwiched between the pixel electrode and the opposed electrode 44 to form the pixel component.

The opposed electrode 44 is in common for laterally adjacent two pixel components. Furthermore, the opposed electrode 44 is commonized for one line. In the lateral direction of FIG. 15, the opposed electrodes 44A, 44B, 44C, 44D, 44E and 44F are applied the voltage at respectively arbitrary timing.

By employing such construction, in comparison with the a first to eleventh embodiments, pixel structure can be simplified to reduce fabrication process for lowering cost.

In the embodiment shown in FIG. 15, the opposed electrode is made common for laterally adjacent two pixel components. However, the opposed electrode can be common for three pixel components of R, G and B. By commmonizing for three pixel components, number of the opposed electrode line 44 can be reduced to increase opening ratio. Also, since one pixel is normally consisted of three pixel components of R, G, B, the opposed electrode can be controlled perpixel to reduce driving and signal processing load.

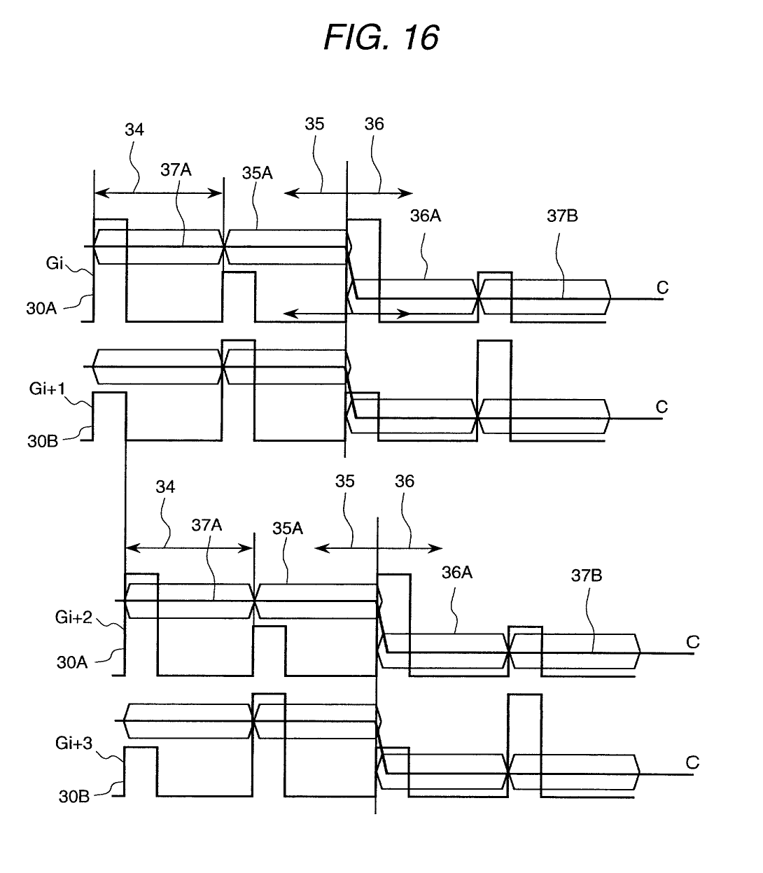

FIG. 16 is a timing chart showing one example of a driving voltage waveform to be applied to each line of FIG. 15 for image zone separation display according to the present invention.

Consideration is given for Gi and Gi+1 of (i)th and (i+1)th scanning line. To the scanning line Gi, two levels of gate voltages 30 is applied per a frame period 34. To the scanning line Gi+1, a voltage 30B obtained by inverting two levels of gate voltage applied to the scanning line Gi, is applied simultaneously.

Here, it is assumed that a region in a period 35 is a high definition display region and a region in a period 36 is a low definition display region. In the high definition display period 35, a potential 37A of the opposed electrode 44 is elevated to be high. At the same time, an image signal 35A is also elevated, simultaneously. The thin film transistor 41 is not turned ON at two low levels of the gate voltages 30A and 30B and the thin transistor 41 is turned ON only at two levels of high potential levels of the gate voltages 30A and 30B, six pixel components are written and remaining six pixels are held at preceding voltage in twelve pixels of 2×2 pixels.

In the next frame, the voltage levels of Gi and Gi+1 of the scanning line 40 are inverted, data of the written pixel components in the preceding frame is held, and data held in the preceding frame is rewritten.

On the other hand, in the low definition display period 36, the potential 37B at the opposed electrode 44 is made low. At this time, the image signal 36A is simultaneously made low to turn ON the thin film transistor 41 together with two levels of gate voltages 30A and 30B. Image is rewritten in all of twelve pixel components of 2×2 pixels.

Accordingly, in the high definition region, image is formed with two frames and in the low definition region, high speed rewriting can be performed per frame.

Next, even on the scanning line Gi+2, Gi+3, similarly, the high definition display region and the low definition display region are discriminated. When the driving waveform is input, image zone separating display can be performed. Accordingly, when the still image is displayed on the high definition display region and the dynamic image is displayed on the low definition display region, the dynamic image is rewritten and the still image is displayed in high definition.

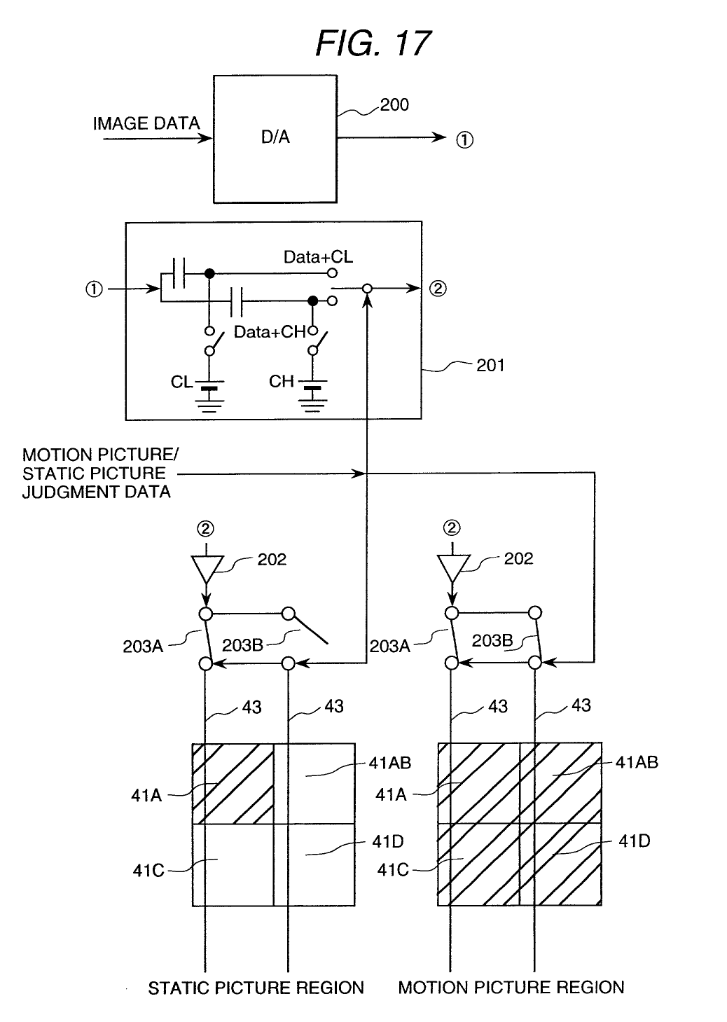

FIG. 17 is a circuit diagram showing a circuit construction for level shifting voltages of image signals 35A and 36A in the twelfth embodiment. At first, the image data from the image signal generating device, such as personal computer or the like, is converted by a D/A converter 200. According to discrimination data of dynamic image and the still image, one of the high level signal 35A and the low level signal 36A is selected by a level shifter 201 to apply a signal to the signal line 43 through an amplifier 202.

At this time, when still image display of high definition, through the signal line 43, the high level signal 35A obtained by the level shifter 201 is applied to one pixel 41 in the pixel block. At the next frame, by writing in the different pixel with holding the currently written pixel component, high definition display becomes possible.

In case of dynamic image display at low definition, through the signal line 43, low level signal 36A obtained by the level shifter 201 is applied to all pixel components in the pixel blocks.

In the twelfth embodiment, in the high definition region, one pixel component in one pixel block is selected and displayed. However, by arranging the level shifter 201 per signal line 43, pixel components 41A and 41D arranged diagonally are written simultaneously. Similarly, pixel components 41B and 41D are written simultaneously.

Upon low definition display, by arranging the level shifter 201 per signal line 43, the pixel components 41A and 41C are written by the same signal. Also, the pixel components 41B and 41D are written by the different same signal, simultaneously.

Accordingly, in the twelfth embodiment, arbitrary region is selected per scanning line 40, multiple definition display becomes possible.

On the other hand, even with simple pixel structure substantially the same as conventional pixel structure, the image zone separation display system can be realized by only dividing opposed electrode.

Furthermore, the shown system can select arbitrary region when number of pixel components are greater than or equal to two, or integer multiple of two pixel components in the direction of scanning line 40.

[Thirteenth Embodiment]

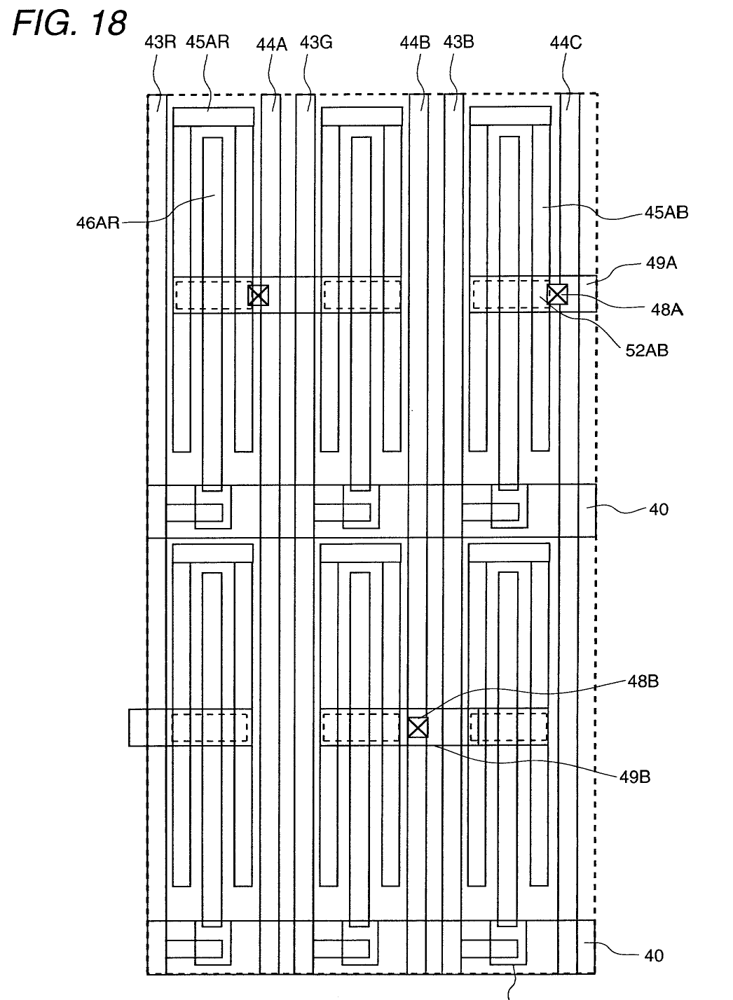

FIG. 18 is a plan view showing the thirteenth embodiment of a pixel structure pattern for realizing image zone separation display according to the present invention.

The thirteenth embodiment is a system for applying the lateral electric field to the liquid crystal layer with the pixel electrode and the opposed electrode on the same substrate in the twelfth embodiment. When one pixel is consisted of three pixel components of red, green and blue, and one block is consisted of four pixels of 2×2 pixels.

To the scanning line 40, the gate electrodes of the thin film transistors 41AR, 41AG, 41AB and so forth as the switch per one pixel component are connected, and to the drain electrode of the thin film transistor 41, the red color image signal line 43R, the green color image signal line 43G and the blue color image signal line 43B are connected, respectively.

To the source electrode of the thin film transistor 41, the pixel electrode is connected. Between the pixel electrode and the opposed electrode 44, the liquid crystal layer is disposed.

The opposed electrode 44 is in common for laterally adjacent two pixel components. Furthermore, the opposed electrode 44 is commonized for one line. The opposed electrode is consisted of the opposed electrodes 44A, 44B, 44C, connected in the pixel via the contact portions 52.

Other effect and operation are similar to those in the twelfth embodiment.

[Fourteenth Embodiment]

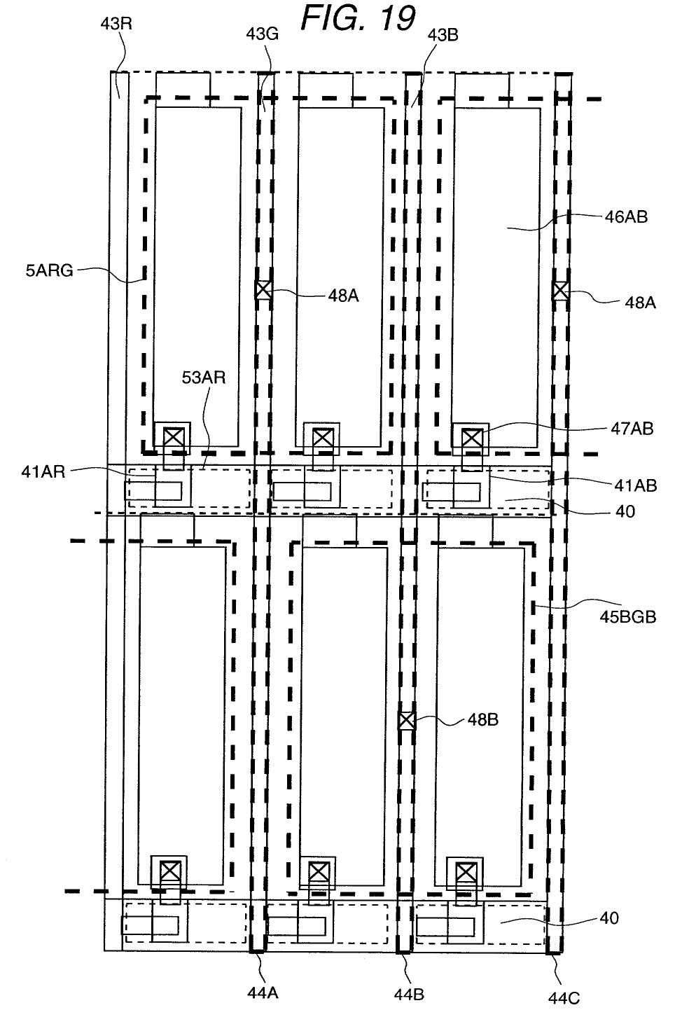

FIG. 19 is a plan view showing the fourteenth embodiment of a pixel structure pattern for realizing image zone separation display according to the present invention.

The fourteenth embodiment is a system for applying the lateral electric field to the liquid crystal layer with the pixel electrode and the opposed electrode on the same substrate in the thirteenth embodiment.

To the scanning line 40, the gate electrodes of the thin film transistors 41AR, 41AG, 41AB and so forth as switch are connected per one pixel component. To the drain electrode of the thin film transistor 41, the red image signal line 43R, the green image signal line 43G and the blue image signal line 43B are connected, respectively.

To the source electrode of the thin film transistor 41, pixel electrode is connected. The liquid crystal layer is sandwiched between the pixel electrode and the opposed electrode 44 to form the pixel component.

The opposed electrode 44 is arranged on the side of the counter substrate and in common for laterally adjacent two pixel components. Furthermore, the opposed electrode 44 is commonized for one line. The opposed electrode is consisted of the opposed electrodes 44A, 44B, 44C, . . . connected in the pixel via the contact portions 48.

While the pixel electrode 45 has to be transparent electrode, the opposed electrodes 44A and 44B may be formed of metal for significantly reduce line resistance.

When the structure of the fourteenth embodiment is employed, opening ratio can be increased significantly.

Other effect and operation are similar to those of the thirteenth embodiment.

[Fifteenth Embodiment]

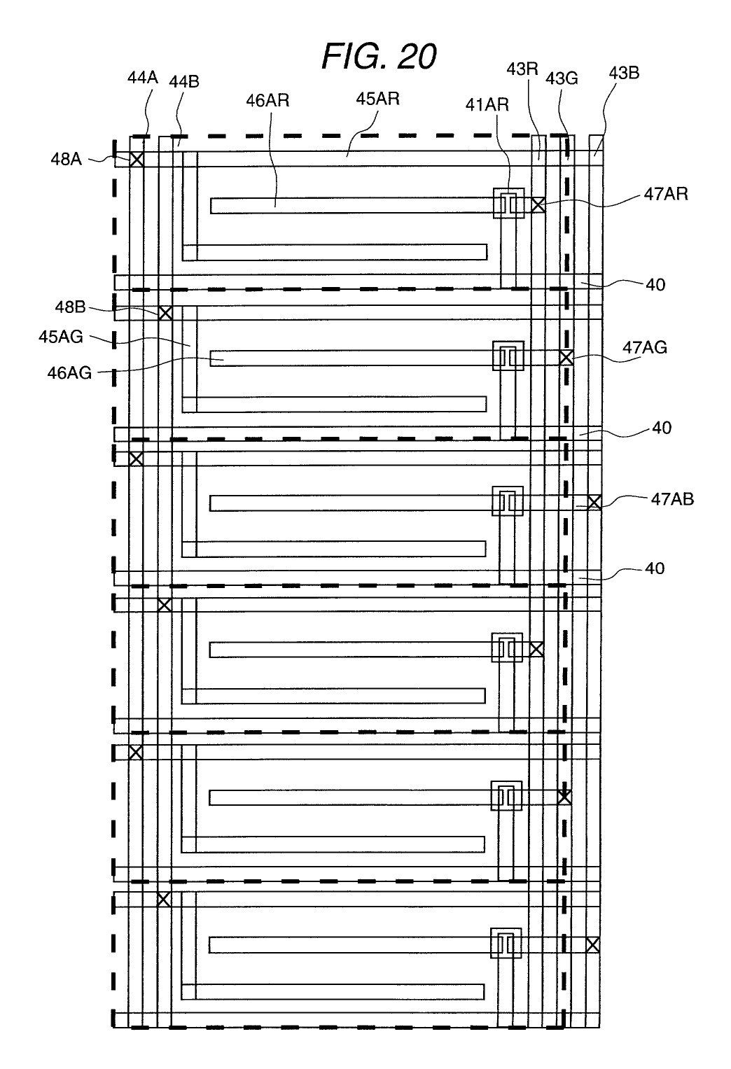

FIG. 20 is a plan view showing the fifteenth embodiment of a pixel structure pattern for realizing image zone separation display according to the present invention.

The fifteenth embodiment is constructed by employing the stripe structure in parallel to the scanning line for the color filter of the thirteenth embodiment.

Other effect and operation are similar to those of the thirteenth embodiment.

[Sixteenth Embodiment]

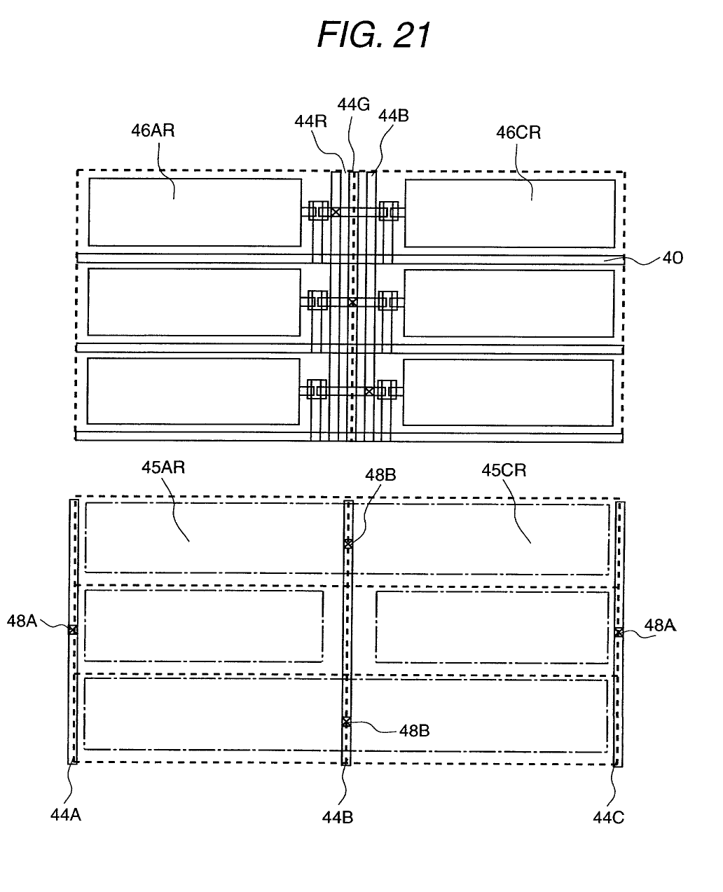

FIG. 21 is a plan view showing the sixteenth embodiment of a pixel structure pattern for realizing image zone separation display according to the present invention.

The opposed electrode 45 on the counter substrate may be divided per two pixels as shown in FIG. 21 and are connected per one line via the contact line 48.

Other effect and operation are similar to those of the fourteenth embodiment.

[Seventeenth Embodiment]

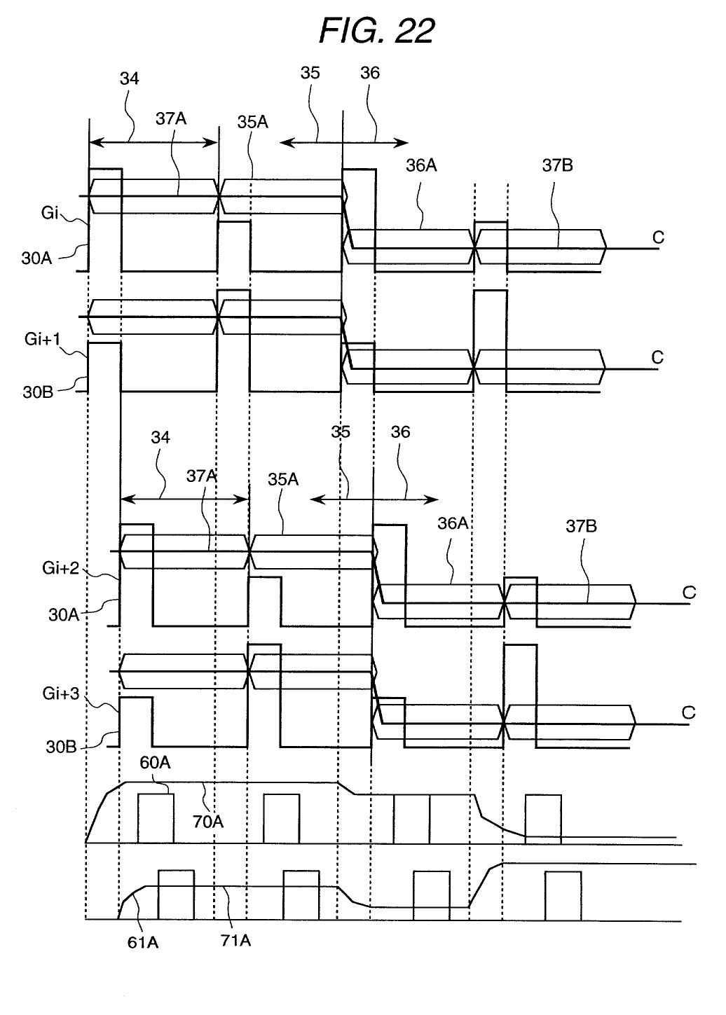

FIG. 22 is a timing chart showing operational waveform of the seventeenth embodiment applied a blink back light for obtaining clear dynamic image in the image zone separating display system according to the present invention.

The seventeenth embodiment is applicable for any embodiment having one switch per one pixel component.

The seventeenth embodiment of the liquid crystal display has a lighting device on a back surface and includes a pair of transparent substrates having a polarizing panel and a liquid crystal layer sandwiched between a pair of transparent substrate, controls orienting condition of the liquid crystal layer by applying an electrical field to the liquid crystal layer for displaying image.

When a coefficient of transmission of the liquid crystal layer is varied as curves 70A and 70B, if the lighting device is illuminated as shown by curves 60A and 61A in synchronism with response of the liquid crystal, clear image can be obtained within a region rewritten at high speed at low definition.

When illumination of the lighting device dividing the high definition region and the low definition region is difficult, in order to prevent fluctuation of brightness in the high definition region and brightness in the low definition region, illumination of the lighting device has to be blinked in synchronism with the scanning line signals 30A and 30B.

[Eighteenth Embodiment]

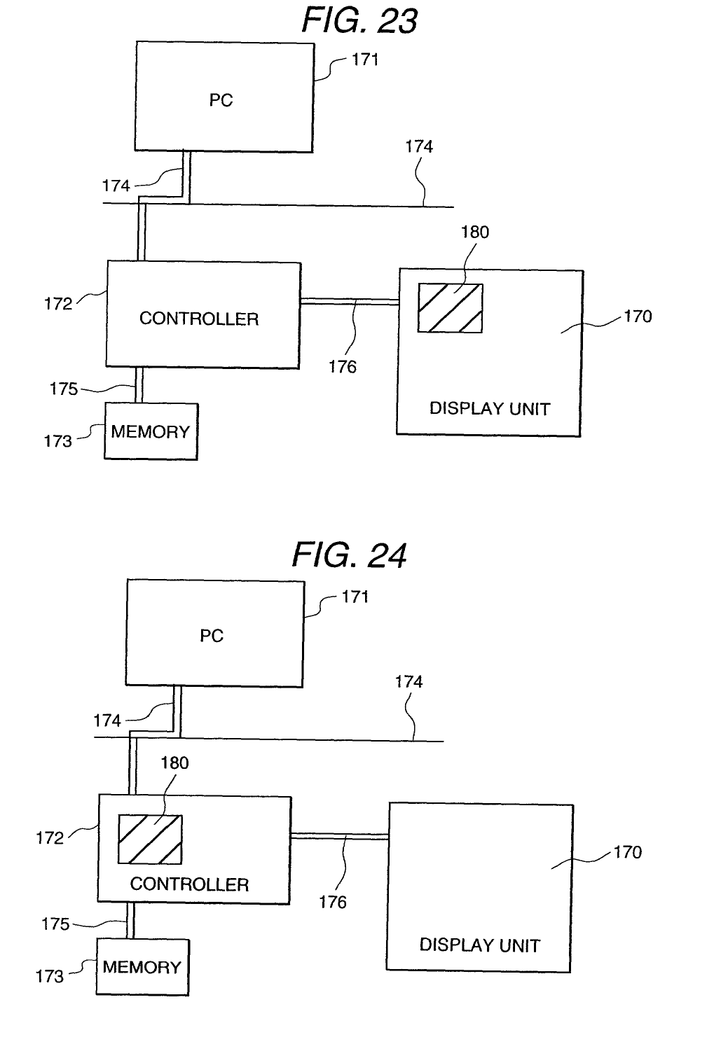

FIG. 23 is a block diagram showing the eighteenth embodiment of an image display system adapted for image zone separating display system according to the present invention. The eighteenth embodiment includes dynamic image/still image discrimination circuit 180 within the image display apparatus 170. The image signal from an image signal generating device 171 generating the image signal, such as personal computer or the like, is input to a display control device 172 as graphic controller, data for the entire screen is accumulated in a frame memory.

The dynamic image/still image discrimination circuit 180 discriminates whether the data from the display control device 172 is dynamic image data or still image to display on the image display apparatus.

With the eighteenth embodiment, by replacing the conventional image display device with the image display device 170, image zone separation substantially achieving both of high definition image display and high speed dynamic image display. It should be noted that the shown embodiment of the image displaying apparatus can not only be a replacement of the conventional image displaying apparatus but also can be used together with the conventional image displaying apparatus.

[Nineteenth Embodiment]

FIG. 24 is a block diagram showing the nineteenth embodiment of an image display system adapted for image zone separating display system according to the present invention. The nineteenth embodiment includes the dynamic image/still image discrimination circuit 180 in the display control device 172 as a graphic controller. The image signal of the personal computer from the image signal generating device 171 is input to the display control device 172 as the graphic controller via bus line 174. The input image signal subject to discrimination between the dynamic image and the still image, and is fed to the conventional image display apparatus to the conventional image display apparatus through the line 176.

With the nineteenth embodiment, the signal frequency in the line 176 can be reduced to permit high density information transfer. On the other hand, in the portion not varied from that preceding frame is transferred data from the frame memory 173 and only portion rewritten in the preceding frame is transferred from the graphic controller 172. Accordingly, load of transmission path following the graphic controller 172 can be decreased to permit high density display.

Furthermore, since the dynamic image/still image discrimination circuit 180 is included, increasing of the size and weight of the image display apparatus 170 can be avoided to maintain the image display apparatus in compact.

[Twentieth Embodiment]

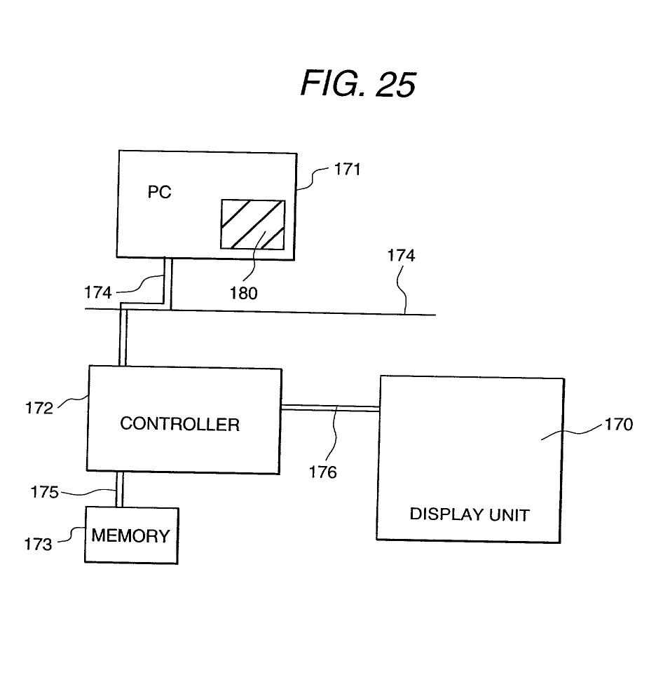

FIG. 25 is a block diagram showing the twentieth embodiment of an image display system adapted for image zone separating display system according to the present invention. The twentieth embodiment includes the dynamic image/still image discrimination circuit 180 in the display control device 172 as a graphic controller. FIG. 25 is a block diagram showing the twentieth embodiment of an image display system adapted for image zone separating display system according to the present invention. The dynamic image/still image discrimination circuit 180 discriminates whether the data from the display control device 172 is dynamic image data or still image to display on the image display apparatus.

With the twentieth embodiment, the load of the paths 174, 175 and 176 can be reduced to permit high speed processing of high density information.

Furthermore, since the dynamic image/still image discrimination circuit 180 is included, increasing of the size and weight of the image display apparatus 170 can be avoided to maintain the image display apparatus in compact.

With the present invention, utilizing human visual characteristics to eliminate information of low recognition level to obtain the image display apparatus which can substantially achieve both of high density still image display and high speed dynamic image display.

Namely, the image display apparatus applied the image zone separation display system which can arbitrarily switch the region for displaying high speed rewriting with lowering definition level of dynamic image and the region for effecting high definition display of the still image at low speed in order to achieve both of high density still image display and high speed dynamic image display.

As a result, the image display apparatus which can perform high definition still image display, high speed dynamic image display, multiple gradation level display and large information amount for achieving satisfactory image quality.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. An image displaying method of an image displaying apparatus having a display portion consisted of a plurality of pixels comprising the steps of:
taking each of a predetermined number of pixels as one block unit;
forming one screen image for displaying by combining a region for displaying the same information on a plurality of pixels in said one block unit during one scanning period and a region for permitting display of respectively different information on said plurality of pixels in said one block unit.

2. An image displaying method of an image displaying apparatus having a display portion consisted of a plurality of pixels comprising the steps of:
taking each of a predetermined number of pixels as one block unit;
discriminating an image to be displayed in each block unit between a dynamic image and a still image;
forming one screen image for displaying by combining a region for displaying the same information on a plurality of pixels in said one block unit during one scanning period and a region for permitting display of respectively different information on said plurality of pixels in said one block unit.

3. An image displaying method as set forth in claim 1 or 2, wherein said respective regions can be switched into regions having an arbitrary size greater than or equal to said one block unit.

4. An image display method as set forth in claim 1 or 2, which further comprises the steps of:
discriminating a definition level of said still image per one block unit; and
displaying the same information in arbitrarily number of plurality of pixels in said one block unit for still image of low definition level.

5. An image display method as set forth in claim 1 or 2, wherein said one screen image is consisted of frames in number less than or equal to number of a plurality pixels forming one block unit, and
said plurality of pixels are selected per frame.

6. An image display method as set forth in claim 1 or 2, which comprises:
arranging a plurality of scanning line and a plurality of signal line of the image displaying apparatus in matrix fashion;
forming switches connected to intersections of said scanning line and said signal line and whereby connected to a plurality of scanning line and a plurality of signal line;
dividing opposed electrode opposing to pixel electrodes connected to said switches per a plurality of pixels; and
applying driving waveforms at different levels to said signal line and said opposed electrode depending upon a region for displaying the same information and a region for permitting display of different information.

7. An image display method as set forth in claim 1 or 2, wherein said image display apparatus is a display device which has a lighting device on a back surface, a pair of transparent substrates having polarizing panel and a liquid crystal layer disposed between said pair of transparent substrates for applying an electrical field to said liquid crystal layer for controlling orienting condition of the liquid crystal layer for displaying the image,
blinking illustration of said lighting device in synchronism with scanning when the region for displaying the same information on a plurality of pixels in one block unit during one scanning period.

8. An image displaying method of an image display system including an image displaying apparatus defined in any one of claims 1 to 7, an image generating device for generating an image signal to be displayed on said image display apparatus, a display control device for controlling said image display apparatus on the basis of said image signal and an information storage device for holding information corresponding to said image signal, comprising the step of:
discriminating a region for displaying said the same information and a region for displaying different information by said image display apparatus.

9. An image displaying method of an image display system including an image displaying apparatus defined in any one of claims 1 to 7, an image generating device for generating an image signal to be displayed on said image display apparatus, a display control device for controlling said image display apparatus on the basis of said image signal and an information storage device for holding information corresponding to said image signal, comprising the step of:
discriminating a region for displaying said the same information and a region for displaying different information by said display control device.

10. An image displaying method of an image display system including an image displaying apparatus defined in any one of claims 1 to 7, an image generating device for generating an image signal to be displayed on said image display apparatus, a display control device for controlling said image display apparatus on the basis of said image signal and an information storage device for holding information corresponding to said image signal, comprising the step of:
discriminating a region for displaying said the same information and a region for displaying different information by said image generating device.

11. An image display apparatus having a display controller for converting an image data into a display data, an image converting circuit and a display panel, comprising:
a frame memory feeding data having different resolution on said display panel and a dynamic image/still image discriminating circuit;
said display panel including a signal driver applying an image data signal to signal line, a control signal driver applying a scanning signal to scanning line and a pixel selection driver for applying a display block selection signal to a selection signal line,
said display panel taking a predetermined number of pixels among a plurality of pixels arranged in matrix fashion as one block unit, and one screen image for displaying is formed by combining a region for displaying the same information on a plurality of pixels in said one block unit during one scanning period and a region for permitting display of respectively different information on said plurality of pixels in said one block unit.

12. An image display apparatus having a display controller for converting an image data into a display data, an image converting circuit and a display panel, comprising:
a frame memory feeding data having different resolution on said display panel and a dynamic image/still image discriminating circuit;
said display panel including a signal driver applying an image data signal to signal line, a control signal driver applying a scanning signal to scanning line and a pixel selection driver for applying a display block selection signal to a selection signal line,
said display panel taking a predetermined number of pixels among a plurality of pixels arranged in matrix fashion as one block unit, and one screen image for displaying is formed by combining a dynamic image region for displaying the same information on a plurality of pixels in said one block unit during one scanning period and a still image region for permitting display of respectively different information on said plurality of pixels in said one block unit,
said dynamic image region is displayed on the basis of a dynamic image data from said dynamic image/still image discriminating circuit, and
said still image region is displayed on the basis of the still image data from said frame memory.

13. An image displaying apparatus as defined in claim 11 or 12, comprises
a lighting device provided on a back surface;
a pair of transparent substrates having polarizing panel;
a liquid crystal layer disposed between said pair of transparent substrates;
one of said pair of transparent substrates having a plurality of said scanning line,
a first signal line and a second signal line formed with a plurality of said scanning lines in a form of matrix, a plurality of first switches formed corresponding to intersections of said plurality of said scanning line and a plurality of said first signal line,
a plurality of second switches formed between a plurality of said second signal line and a plurality of said first switches,
one of said pair of transparent substrate having a opposed electrode,
an electric field being applied between said pixel electrodes and said opposed electrode, and
an image being displayed by controlling orienting condition of said liquid crystal.

14. An image displaying apparatus as set forth in claim 11 or 12, wherein said display panel has pixel electrode and opposed electrode for applying a lateral electric field to the pixel portion of said pixel and said opposed electrode.

15. An image displaying apparatus as set forth in claim 11 or 13, wherein said display panel has the pixel electrode on one of said transparent substrates and the opposed electrode on the other transparent substrate in order to apply a vertical electric field to pixel portion of said pixel.

16. An image displaying apparatus as set forth in claim 13, wherein a color filter mounted on the pixel portion of said pixel has a stripe structure parallel to said scanning line.

17. An image displaying apparatus as set forth in claim 13, wherein said lighting device has lighting control means for moving a light emitting region in synchronism with a scanning signal applied to said scanning line.

18. An image displaying apparatus as set forth in claim 11 or 12, which comprises
a lighting device provided on a back surface;
a pair of transparent substrates having polarizing panel;
a liquid crystal layer disposed between said pair of transparent substrates;
one of said pair of transparent substrates having a plurality of said scanning line,
a first signal line and a second signal line formed with a plurality of said scanning lines in a form of matrix,
a plurality of first switches formed corresponding to intersections of said plurality of said scanning line and a plurality of said first signal line,
a plurality of second switches formed between a plurality of said second signal line and a plurality of said first switches,
pixel electrode connected to a plurality of said first switches or a plurality of said second switches,
opposed electrode connected to a plurality of said first switches or a plurality of said second switches,
an electric field being applied between said pixel electrodes and said opposed electrode, and
an image being displayed by controlling orienting condition of said liquid crystal.

19. An image displaying apparatus as set forth in claim 11 or 12, which comprises
a lighting device provided on a back surface;
a pair of transparent substrates having polarizing panel;
a liquid crystal layer disposed between said pair of transparent substrates;
one of said pair of transparent substrates having a plurality of said scanning line,
a first signal line and a second signal line formed with a plurality of said scanning lines in a form of matrix,
a plurality of first switches formed corresponding to intersections of said plurality of said scanning line and a plurality of said first signal line,
a plurality of second switches formed between a plurality of said second signal line and a plurality of said first switches,
pixel electrode connected to a plurality of said second switches,
opposed electrode on one of said pair of transparent substrate,
an electric field being applied between said pixel electrodes and said opposed electrode, and
an image being displayed by controlling orienting condition of said liquid crystal.

20. An image displaying apparatus as set forth in claim 18, wherein said display panel has one of pixel electrode and opposed electrode for applying a lateral electric field to pixel portion of said pixel.

21. An image displaying apparatus as set forth in claim 19, wherein said display panel has one of pixel electrode and opposed electrode for applying a lateral electric field to pixel portion of said pixel.

22. An image displaying apparatus as set forth in claim 18, wherein said display panel has one of pixel electrode and opposed electrode for applying a vertical electric field to pixel portion of said pixel.

23. An image displaying apparatus as set forth in claim 19, wherein said display panel has one of pixel electrode and opposed electrode for applying a vertical electric field to pixel portion of said pixel.

24. An image displaying apparatus as set forth in claim 18, wherein a color filter mounted on the pixel portion of said pixel is a stripe structure parallel to said scanning line.

25. An image displaying apparatus as set forth in claim 19, wherein a color filter mounted on the pixel portion of said pixel is a stripe structure parallel to said scanning line.

26. An image displaying apparatus as set forth in claim 18, wherein said lighting device has light emission control means for shifting light emitting region in synchronism with the scanning signal applied to said scanning line.

27. An image displaying apparatus as set forth in claim 19, wherein said lighting device has light emission control means for shifting light emitting region in synchronism with the scanning signal applied to said scanning line.

28. An image displaying apparatus as set forth in claim 11 or 12, which comprises
a lighting device provided on a back surface;
a pair of transparent substrates having polarizing panel;
a liquid crystal layer disposed between said pair of transparent substrates;
one of said pair of transparent substrates having a plurality of said scanning line,
a first signal line and a second signal line formed with a plurality of said scanning lines in a form of matrix,
a plurality of switches formed corresponding to intersections of said plurality of said scanning line and a plurality of said first signal line,
pixel electrode connected to a plurality of said switches,
opposed electrode formed on one of said pair of transparent substrates and divided per a plurality of pixels,
an electric field being applied between said pixel electrodes and said opposed electrode, and
an image being displayed by controlling orienting condition of said liquid crystal.

29. An image displaying apparatus as set forth in claim 28, wherein said display panel has pixel electrode for applying lateral electric field to the pixel portion of said pixel and the opposed electrode.

30. An image displaying apparatus as set forth in claim 28, wherein said display panel has pixel electrode provided on one of said pair of transparent substrates for applying vertical electric field to the pixel portion of said pixel and the opposed electrode provided on the other transparent substrate.

31. An image displaying apparatus as set forth in claim 28, wherein a color filter mounted on the pixel portion of said pixel has a stripe structure parallel to said scanning line.

32. An image displaying apparatus as set forth in claim 28, wherein said lighting device has lighting control means for moving a light emitting region in synchronism with a scanning signal applied to said scanning line.

33. An image displaying apparatus as set forth in claim 28, wherein selection signal level to be applied to said scanning line controlling condition of said switch and selection signal level to be applied to said opposed electrode are selection signal level having more than or equal to two values, and
a level shifter is provided for varying level of an image data signal to be applied to said signal line adapting to the selection signal level of said opposed electrode.

34. An image displaying apparatus as set forth in claim 33, wherein one block unit is formed with predetermined number of pixels,
said scanning line selection signal level and said opposed electrode signal level for the same display on a plurality of pixels in said one block unit in one scanning period and said scanning line selection signal level and said opposed electrode signal level for selecting arbitrary pixel in said one block unit,
switching means is provided for switching the region for the same display on a plurality of pixels in said one block unit in one scanning period and the region permitting different display on a plurality of pixels in one block unit for a plurality times of scan.

35. An image display apparatus as set forth in claim 33, wherein said lighting device has lighting control means for moving a light emitting region in synchronism with a scanning signal applied to said scanning line.

36. An image displaying system comprising:
an image displaying apparatus having a display panel;
an image generating device generating an image signal displaying on said display panel;
a display control device controlling said image displaying apparatus on the basis of said image signal; and
a frame memory for holding information corresponding to said image signal connected to said display control device,
said image displaying apparatus including a dynamic image and a still image discriminating means for discriminating between the dynamic image and the still image,
said display panel taking a predetermined number of pixels among a plurality of pixels arranged in matrix fashion as one block unit, and one screen image for displaying is formed by combining a dynamic image region for displaying the same information on a plurality of pixels in said one block unit during one scanning period and a still image region for permitting display of respectively different information on said plurality of pixels in said one block unit.

37. An image displaying system comprising:
an image displaying apparatus having a display panel;
an image generating device generating an image signal displaying on said display panel;
a display control device controlling said image displaying apparatus on the basis of said image signal; and
a frame memory for holding information corresponding to said image signal connected to said display control device,
said display control device including a dynamic image and a still image discriminating means for discriminating between the dynamic image and the still image,
said display panel taking a predetermined number of pixels among a plurality of pixels arranged in matrix fashion as one block unit, and one screen image for displaying is formed by combining a dynamic image region for displaying the same information on a plurality of pixels in said one block unit during one scanning period and a still image region for permitting display of respectively different information on said plurality of pixels in said one block unit.

38. An image displaying system comprising:
an image displaying apparatus having a display panel;
an image generating device generating an image signal displaying on said display panel;
a display control device controlling said image displaying apparatus on the basis of said image signal; and
a frame memory for holding information corresponding to said image signal connected to said display control device,
said image generating device including a dynamic image and a still image discriminating means for discriminating between the dynamic image and the still image,
said display panel taking a predetermined number of pixels among a plurality of pixels arranged in matrix fashion as one block unit, and one screen image for displaying is formed by combining a dynamic image region for displaying the same information on a plurality of pixels in said one block unit during one scanning period and a still image region for permitting display of respectively different information on said plurality of pixels in said one block unit.
